(19) United States
(12) Patent Application Publication
(10) Pub. No.: US 2026/0152402 A1
(43) Pub. Date: Jun. 4, 2026

(54) NOVEL HIGH ENTROPY MX-ENES, TRANSITION METALS, AND METHODS OF MAKING

(71) Applicant: Purdue Research Foundation, West Lafayette, IN (US)

(72) Inventors: Babak Anasori, Fishers, IN (US); Brian Cecil Wyatt, JR., Indianapolis, IN (US)

(73) Assignee: Purdue Research Foundation, West Lafayette, IN (US)

(21) Appl. No.: 19/392,990

(22) Filed: Nov. 18, 2025

Related U.S. Application Data
(60) Provisional application No. 63/726,714, filed on Dec. 2, 2024.

(51) Int. Cl. C01B 32/907

(52) U.S. Cl. CPC C01B 32/907; C01P 2002/72; C01P 2002/82; C01P 2002/85; C01P 2004/03; C01P 2004/04; C01P 2006/22; C01P 2006/40

(57) ABSTRACT

A Composition of matter defined by the general formula of M1M2M3M4M5M6M7M8M9X₃, wherein: X is Carbon; and M1, M2, M3, M4, M5, M6, M7, M8 and M9 each represent a different transition metal selected from the group consisting of Ti, Ta, Sc, Cr, Zr, Hf, Mo, and Nb.

### CROSS-REFERENCE TO RELATED APPLICATIONS

The present U.S. patent application claims the priority benefit of U.S. Provisional Patent Application Ser. No. 63/726,714, filed Dec. 2, 2024, the contents of which is hereby incorporated by reference in its entirety.

### STATEMENT OF GOVERNMENT SUPPORT

This invention was made with government support under grant 2419026 awarded by the National Science Foundation. The government has certain rights in the invention.

### TECHNICAL FIELD

The present disclosure generally relates to the area of carbide materials containing from 2 to 9 transition metals arranged in ordered structures. In particular, the present disclosure describes the unique formation of compositions incorporating from 8 to 9 transition metals. Such carbide materials have been termed MXenes and have a wide range of applications, including semi-permeable barriers, absorbent/sorbent material, battery and rechargeable battery construction, antennas, cable shielding, thin film formation, ordered arrays, and the like.

### BACKGROUND

High-entropy materials containing four or more metallic elements are a major research area in materials science. However, the moniker “high-entropy” has become a major source of disagreement in the materials community due to the unclear contributions of entropy vs. enthalpy toward their behavior. In our work, we show that entropy-stabilized MAX phases containing 2 to 9 transition metals retain their enthalpic preference for short-range order until entropy increases enough to achieve all configurations of the transition metals in their atomic planes. Therefore, we argue that “high-entropy” is only achieved once these enthalpic barriers for ordering are overcome. Lastly, we synthesize the two-dimensional (2D) counterparts, known as MXenes, and show some effects of the order vs. disorder on their surface and electronic behavior. This study indicates that short-range ordering in high-entropy materials must be critically evaluated as to the impact of entropy vs. enthalpy on their structure and properties.

Since their study gained pace in the late Industrial Revolution, the use of alloying different elements as a tool to enhance the properties of metals has proven to be a critical advancement in meeting many technological demands that brought us into the modern age. However, in the early 2000s, novel alloys containing stoichiometric mixtures of metallic elements were systematically explored. These alloys demonstrated increased mechanical properties and decreased thermal conductivity beyond normal expectations of the “rule of mixture” approximations. Energetically, in one of the early studies, it was proposed that increasing the number of these metals could result in entropy-stabilization of enthalpically unfavorable mixtures of elements. This has been shown in metallic alloys, carbides, oxides, diborides, and other ceramics.

Early on, such entropy-stabilized structures took on the moniker of “high-entropy”, which was due to the large contribution of configurational entropy in Gibbs' free energy. However, since this moniker became popular, there has been pushback to using “high-entropy” as a general label, as it can obfuscate the major effect enthalpy still has on the stability of a single-phase system. For example, short-range ordering in some high-entropy systems suggests that some enthalpic effects must still be present. Specifically, the short-range order in these “high-entropy” systems indicates that, while configurational entropy can stabilize some single-phase structures that are enthalpically resistant to form, configurational entropy alone may not be enough to stabilize all possible configurations. Therefore, we believe that the claim of short-range ordering in multi-compositional material systems labeled as “high-entropy” indicates a fundamental need to evaluate the true role of configurational entropy vs. enthalpy to the achieved configurations in a single-phase material. This study aims at the understanding of the entropy role in the overcoming of short-range ordering in MAX phases.

MAX phases are a large family of transitional metal carbides and nitrides that are chemically denoted by their formula Mₙ₊₁AXₙ, where M refers to n+1 layers of one or more early transition metals that are interleaved by X, which represents n layers of carbon/nitrogen. Between each of these Mₙ₊₁Xₙ slabs, there is a single layer of one or more A elements. M is ionic/covalently bound to X, similar to a transition metal carbide, while the surface M of each Mₙ₊₁Xₙ slab is metallically bound to the A element. As a result of this M-X vs. M-A bonding, there can be a preference for the chemical ordering of two or more transition metals in separate transition metal planes. In M₃AX₂ or M₄AX₃ systems, some transition metals prefer M sites closest to A (M′ layers) or M sites only bound to X (M″), which is referred to as o-MAX. Examples of these M₄AX₃ o-MAX systems include Mo₂Ti₂AlC₃ and Mo₂Nb₂AlC₃, where the formula is expanded as M′₂M″₂AX₃ to indicate that Mo occupies M′ sites while Ti/Nb occupies M″ sites.

Although these o-MAX phases have been reported, the preference for an M′ vs. an M″ site in MAX phases is not fully understood. Computationally, it has been shown that Group 6 transition metals, such as Cr, Mo, and W enthalpically prefer exterior M′ sites while Group 4 transition metals, such as Ti, Zr, and Hf enthalpically prefer M″ sites. Similarly, the earliest reported “high-entropy” MXenes, in 2021, (TiVCrMo)₄C₃ and (TiVNbMo)₄C₃, still energetically prefer Cr and Mo in M′ sites and Ti and Nb in M″ sites. As MXenes are derived from their precursor MAX phases, this suggests that even in entropy-stabilized MAX phases, this enthalpic preference of M′ or M″ site occupancy is likely present. To the point of this work, we believe that MAX and MXenes provide a unique material system to demonstrate the effects of enthalpy vs. entropy on the order-to-disorder transition. Therefore, this work establishes the synthesis of multi-transition metal MAX phases, the trends in the ordering and disordering of their transition metals due to enthalpy and entropy, and demonstrates some of the surface and electronic properties of their synthesized MXenes.

U.S. Patent publication No. US20220115660A1 describes high entropy MXenes and methods of making them resulting in compositions of M1, M2, M3, and M4 each representing different transition metals.

U.S. Patent publication No. US20220112582A1 describes Rare Earth Element MXenes and methods of making thereof.

U.S. Patent publication No. US20230174787A1 describes MXenes-Metal and ceramic assemblies and composites.

U.S. patent Ser. No. 11/773,480B2 describes the use of MXene compositions as templates for the deposition of oriented perovskite films.

U.S. Pat. No. 11,202,398 B2 describes electromagnetic shielding material and method for producing the same.

U.S. Patent Publication No. US20230038621A1 describes antennas for transmission and receiving electrical signals comprising a MXene composition.

U.S. Patent Publication No. US20200303736A1 describes two-dimensional, ordered, double transition metal carbides.

International Publication Number WO 2021/072150 A1 (15 Apr. 2021) describes MXene compositions featuring five atomic layers.

### BRIEF SUMMARY

The present disclosure generally relates to M8 and M9 MXenes, methods of making and use.

The present disclosure provides for a Composition of matter defined by the general formula of M1M2M3M4M5M6M7M8M9X₃, wherein: X is Carbon; and M1, M2, M3, M4, M5, M6, M7, M8 and M9 each represent a different transition metal selected from the group consisting of Ti, V, Cr, Zr, Nb, Mo, Hf, Ta, and W.

The present disclosure provides for a Composition of matter defined by the general formula of M1M2M3M4M5M6M7M8M9X₃, wherein: X is Carbon; and M1, M2, M3, M4, M5, M6, M7, M8 and M9 each represent a different transition metal selected from the group consisting of Ti, V, Cr, Zr, Nb, Mo, Hf, Ta, and W, wherein M1, M2, M3, M4, M5, M6, M7, M8 and M9 each represent a different transition metal selected from the group consisting of consisting of Ti, V, Cr, Zr, Nb, Mo, Hf, Ta, and W.

Thus the present disclosure provides for the composition as described, wherein the composition is (TiVCrZrNbMoHfTaW)₄C₃. Further providing for the composition as described, wherein the composition is a MXene.

The present disclosure describes a composition as above, wherein the composition is produced by at least:
preparing a precursor MAX phase powder;
etching the MAX phase powder to obtain multi-layered MXene powder; and
determining the multi-layered MXene powder to obtain single-to-few-layered MXene flakes.

The present disclosure describes a composition as above, wherein preparing precursor MAX phase powder includes mixing and reactive sintering elemental powders of equimolar ratio of four transition metals M′, M², M³, and M⁴ with Al and C M′:M²:M³:M⁴:Al:C in 1:1:1 :1:1.1:2.7 stoichiometric ratio to obtain one or more sintered MAX phase blocks.

The present disclosure describes a composition as above, wherein the MAX phase structures having the formula M₄AlC₃ with 4 transition metals selected from the group consisting of: (TiVNbTa)₄AlC₃, (TiVNbW)₄AlC₃, and (TiCrMoW)₄AlC₃.

The present disclosure describes a composition as above, with different formation energy when V and W occupy only M′ sites and Ti and Nb occupy only M″ sites in (TiVNbW)₄AlC₃, and, if Ti and Nb occupy only M′ sites and V and W occupy only M″ sites (labeled “inverse ordered”), and when the solid solution occupancies of Ti and Nb in M′ and M″ sites have a higher formation energy for (TiVNbW)₄AlC₃.

The present disclosure describes a method of producing a composition of matter defined by the general formula of M1M2M3M4M5M6M7M8M9X₃, the method comprising:
preparing precursor MAX phase powder;
etching the MAX phase powder to obtain multi-layered MXene powder; and
delaminating the multi-layered MXene powder to obtain
single-to-few-layered MXene flakes having the general formula of M1M2M3M4M5M6M7M8M9X₃;
wherein:
X is carbon; and
M1, M2, M3, M4, M5, M6, M7, M8 and M9 each represent a different transition metal selected from the group consisting of Ti, V, Cr, Zr, Nb, Mo, Hf, Ta, and W.

The present disclosure describes a method as above, where the composition of claim 9, wherein the composition is (TiVCrZrNbMoHfTaW)₄C₃.

The present disclosure describes a composition that is a film comprising M₄C₃Tₓ MXenes containing 2 to 9 transition metals wherein;
X is carbon;
M is selected from the group consisting of M1, M2, M3, M4, M5, M6, M7, M8 and M9, each represent a different transition metal selected from the group consisting of Ti, V, Cr, Zr, Nb, Mo, Hf, Ta, and W;
and Tx groups, selected from —O, —(OH), and —F.

The present disclosure encompasses a film having and produced from MAX phase powder having the general formula (TiVNbMo)₄C₃Tx and further provides for a film as described having the formula (TiVCrZrNbMoHfTaW)₄C₃Tx.

These and other features, aspects and advantages of the methods of the present disclosure will become better understood with reference to the following drawings, descriptions and claims.

### BRIEF DESCRIPTION OF THE FIGURES

This patent or application file contains at least one drawing executed in color. Copies of this patent or patent application publication with color drawing(s) will be provided by the Office upon request and payment of the necessary fee.

A better understanding of the present disclosure will be obtained upon reference to the following description in conjunction with the accompanying drawings.

FIG. 1. Enthalpy vs. entropy competition toward order-disorder in M₄AlC₃ MAX phases. (a) Schematic showing the hypothesis of increasing disorder with increasing configurational entropy in M₄AlC₃ MAX phases. (b) Formation energies for different pairs of transition metals in either M′ or M″ sites in M₄AlC₃ MAX. (c) Difference in formation energies for different pairs of transition metals in either M′ or M″ sites in M₄AlC₃ MAX. (d) Proposed model for identifying entropy stabilizable configurations in a single-phase structure. (e-g) Formation enthalpy vs. entropy in M₄AlC₃ MAX phases containing (e) 4, (f) 6, and (g) 7 transition metals.

FIG. 2. Synthesis and analysis of synthesized (TiVCrZrNbMoHfTaW)₄AlC₃ and other M₄AlC₃ phases containing 2-9 transition metals. FIG. 2 (a) Schematic highlighting the mixed elements and synthesis approach. FIG. 2 (b) Crystal structure of the targeted M₄AlC₃ MAX phase. FIG. 2 (c) Electron microscopy image of a grain of (TiVCrZrNbMoHfTaW)₄AlC₃ MAX. FIG. 2 (d-m) Elemental mapping of (TiVCrZrNbMoHfTaW)₄AlC₃ MAX for each element (minus C). FIG. 2 (n) Secondary ion mass spectrometry (SIMS) measurements show the preference for sites based on the transition metal and the total number of transition metals in M₄AlC₃ MAX FIG. 2 (o) SIMS shows the decreasing preference for different sites in M₄AlC₃ MAX plotted against the increasing numbers of transition metals. FIG. 2 (p) Decrease in standard deviation in the ordering term a as calculated by SIMS plotted against the increasing numbers of transition metals.

FIG. 3. Synthesis, surface chemistry, and properties of M₄C₃Tₓ MXenes containing 2-9 transition metals. FIG. 3 (a) Schematic of the synthesis process of M₄C₃Tₓ MXenes from M₄AlC₃ MAX. FIG. 3 (b) Differences in formation energy of pairs of transition metals in M₄C₃Tₓ with O vs. F in Tₓ. FIG. 3 (c-d) Composition of O and F, respectively, on Ti, V, and Mo in M₄C₃Tₓ MXenes against the valence electron concentration (VEC) in the M″ layers. The dotted lines are guides for the eye. FIG. 3 (e) Electrical resistivity behavior of M₄C₃Tₓ MXenes containing 2-9 transition metals. FIG. 3 (f) IR emissivity at 7 m wavelength plotted against the total number of transition metals in the M₄C₃Tₓ MXenes.

FIG. 4. Depicts A symmetric model of a pair (M₁ and M₂) of transition metals in either M′ or M″ layers (M₁-M₂-M₂-M₁) for all possible pairs of our 9 transition metals, x, y=Cr, Mo, W, V, Nb, Ta, Ti, Zr and Hf.

FIG. 5. Depicts Formation energy for various pairs of transition metals in either M′ or M″ sites.

FIG. 6. Depicts Effect of the pairing of transition metals in M′ sites in 4 transition metal M₄AlC₃ MAX on the formation energy of the MAX phase.

FIG. 7. Depicts and shows: Structure of the 4TMs MAX phase with varying degrees of ordering. M₁, M₂, M₃, and M₄ represent different TM elements, indicated by distinct colors.

FIG. 7 a-c) Ordering schemes with outer-layer preference for M₁ and M₄. The choice of intra-layer ordering are FIG. 7 a) single element; FIG. 7 b) binary phase separation, indicated by MᵢMⱼ; and FIG. 7 c) random mixing, indicated by (MᵢMⱼ). FIG. 7 d) A completely random mix of 4 elements. FIG. 7 e) Formation energy (E_{f}) for pure TM Max phase as reference. FIG. 7 f) Formation energy (E_{f}) with varying degrees of ordering in the (TiCrMoW)₄AlC₃, (TiWVNb)₄AlC₃ and (TiVNbTa)₄AlC₃ systems.

FIG. 8. Depicts and shows: Structure of the 6TM and 7TM MAX phase with varying degrees of ordering. FIG. 8 (a) Different investigated ordering configurations of M₁, M₂, M₃, M₄, M₅, and M₆ (represented by different TM elements indicated by distinct colors). FIG. 8 (a-b) The simulated structures of the 6TM with M₁, M₂, and M₃ with outer-layer preference. The intra-layer arrangements are (a) phase-separated and FIG. 8 (b) random. FIG. 8 (c) The structure of a completely random mix of the 6TM elements. FIG. 8 (d) A comparison of the formation energy (E_{f}) for varying degrees of ordering in the system. FIG. 8 (e) Different investigated ordering configurations of M₁, M₂, M₃, M₄, M₅, M₆, and M₇ (represented by different TM elements indicated by distinct colors). FIG. 8 (a-b) The simulated structures of the 7TM with M₁, M₂, M₃, and M₇ with outer-layer preference. The intra-layer arrangements are FIG. 8 (f) phase-separated and FIG. 8 (g) random. FIG. 8 (h) The structure of a completely random mix of the 7TM elements. FIG. 8 (d) A comparison of the E_{f} for varying degrees of ordering in the system.

FIG. 9. Depicts and shows: The theory of order-disorder transition used in this manuscript and the distributions of formation energies based on different configurations in the M₄AlC₃ MAX phases containing 4, 6, and 7 transition metals.

FIG. 10. Depicts and shows: Calculated low-angle x-ray diffraction (XRD) patterns for different pairs of M in M₄AlC₃ phases. FIG. 10 (a-c) XRD patterns for Ti, Zr, and Hf, respectively, in the M″ sites with changing M′ elements. FIG. 10 (d) Calculated peak intensity ratio between the (002)/(004) peaks for the XRD shown in FIG. 10 (a-c). FIG. 10 (e-g) XRD patterns for Cr, Mo, and W, respectively, in the M′ sites with changing M″ elements. FIG. 10 (h) Calculated peak intensity ratio between the (002)/(004) peaks for the XRD shown in FIG. 10 (e-g).

FIG. 11. Depicts and shows: Experimental XRD observations based on the 33 reported MAX phases. FIG. 11(a) Raw low-angle XRD patterns focusing on the (002) and (004) peaks for MAX phases containing between 2-9 transition metals. FIG. 11 (b) Calculated (002)/(004) peak intensity ratios for all 33 MAX phases plotted against the total number of transition metals in the structure. FIG. 11 (c) Calculated deviations of the lattice constants from Vegard's law (“perfect” solid solution lattice constants) and lattice strain as a function of the number of M in the MAX.

FIG. 12. Shows in: FIG. 12 (a) SEM, FIG. 12 (b) SIMS composition, FIG. 12 (c) XRD results, and (d) a ordering parameters for (TiVCrW)₄AlC₃ MAX phase.

FIG. 13. Shows in: FIG. 13 (a) SEM, FIG. 13 (b) SIMS composition, FIG. 13 (c) XRD results, and FIG. 13 (d) a ordering parameters for (TiVZrMo)₄AlC₃ MAX phase.

FIG. 14. Shows in: FIG. 14 (a) SEM, FIG. 14 (b) SIMS composition, FIG. 14 (c) XRD results, and FIG. 14 (d) a ordering parameters for (TiVZrW)₄AlC₃ MAX phase.

FIG. 15. Shows in: FIG. 15 (a) XRD results, FIG. 15 (b) SIMS composition, and FIG. 15 (c) a ordering parameters for (TiVNbW)₄AlC₃ MAX phase.

FIG. 16. Shows in: FIG. 16 (a) XRD results, FIG. 16 (b) SIMS composition, and FIG. 16 (c) a ordering parameters for (TiVMoW)₄AlC₃ MAX phase.

FIG. 17. Shows in: FIG. 17 (a) XRD results, FIG. 17 (b) SIMS composition, and FIG. 17 (c) a ordering parameters for (TiVHfW)₄AlC₃ MAX phase.

FIG. 18. Shows in: FIG. 18 (a) SEM, FIG. 18 (b) SIMS composition, FIG. 18 (c) XRD results, and FIG. 18 (d) a ordering parameters for (TiVTaW)₄AlC₃ MAX phase.

FIG. 19. Shows in: FIG. 19 (a) SEM, FIG. 19 (b) SIMS composition, FIG. 19 (c) XRD results, and FIG. 19 (d) a ordering parameters for (TiVCrZrW)₄AlC₃ MAX phase.

FIG. 20. Shows in: FIG. 20 (a) SEM, FIG. 20 (b) SIMS composition, FIG. 20 (c) XRD results, and FIG. 20 (d) a ordering parameters for (TiVCrNbW)₄AlC₃ MAX phase.

FIG. 21. Shows in: FIG. 21 (a) SEM, FIG. 21 (b) SIMS composition, FIG. 21 (c) XRD results, and FIG. 21 (d) a ordering parameters for (TiVCrMoW)₄AlC₃ MAX phase.

FIG. 22. Shows in: FIG. 22 (a) SEM, FIG. 22 (b) SIMS composition, FIG. 22 (c) XRD results, and FIG. 22 (d) a ordering parameters for (TiVCrHfW)₄AlC₃ MAX phase.

FIG. 23. Shows in: FIG. 23 (a) SEM, FIG. 23 (b) SIMS composition, FIG. 23 (c) XRD results, and FIG. 23 (d) a ordering parameters for (TiVZrMoW)₄AlC₃ MAX phase.

FIG. 24. Shows in: FIG. 24 (a) XRD results, FIG. 24 (b) SIMS composition, and FIG. 24 (c) a ordering parameters for (TiVNbMoW)₄AlC₃ MAX phase.

FIG. 25. Shows in: FIG. 25 (a) SEM, FIG. 25 (b) SIMS composition, FIG. 25 (c) XRD results, and FIG. 25 (d) a ordering parameters for (TiVNbHfW)₄AlC₃ MAX phase.

FIG. 26. Shows in: FIG. 26 (a) SEM, FIG. 26 (b) SIMS composition, FIG. 26 (c) XRD results, and FIG. 26 (d) a ordering parameters for (TiVCrZrMoW)₄AlC₃ MAX phase.

FIG. 27. Shows in: FIG. 27 (a) SEM, FIG. 27 (b) SIMS composition, FIG. 27 (c) XRD results, and (d) a ordering parameters for (TiVCrNbMoW)₄AlC₃ MAX phase.

FIG. 28. Shows in: FIG. 28 (a) SEM, FIG. 28 (b) SIMS composition, FIG. 28 (c) XRD results, and FIG. 28 (d) a ordering parameters for (TiVCrNbHfW)₄AlC₃ MAX phase.

FIG. 29. Shows in: FIG. 29 (a) SEM, FIG. 29 (b) SIMS composition, FIG. 29 (c) XRD results, and FIG. 29 (d) a ordering parameters for (TiVCrNbTaW)₄AlC₃ MAX phase.

FIG. 30. Shows in: FIG. 30 (a) SEM, FIG. 30 (b) SIMS composition, FIG. 30 (c) XRD results, and FIG. 30 (d) a ordering parameters for (TiVZrNbMoW)₄AlC₃ MAX phase.

FIG. 31. Shows in: FIG. 31 (a) SEM, FIG. 31 (b) SIMS composition, FIG. 31 (c) XRD results, and FIG. 31 (d) a ordering parameters for (TiVNbMoHfW)₄AlC₃ MAX phase.

FIG. 32. Shows in: FIG. 32 (a) XRD results, FIG. 32 (b) SIMS composition, and FIG. 32 (c) a ordering parameters for (TiVNbMoTaW)₄AlC₃ MAX phase.

FIG. 33. Shows in: FIG. 33 (a) SEM, FIG. 33 (b) SIMS composition, FIG. 33 (c) XRD results, and FIG. 33 (d) a ordering parameters for (TiVCrNbMoHfW)₄AlC₃ MAX phase.

FIG. 34. Shows in: FIG. 34 (a) SEM, FIG. 34 (b) SIMS composition, FIG. 34 (c) XRD results, and FIG. 34 (d) a ordering parameters for (TiVCrNbMoTaW)₄AlC₃ MAX phase.

FIG. 35. Shows in: FIG. 35 (a) SEM, FIG. 35 (b) SIMS composition, FIG. 35 (c) XRD results, and FIG. 35 (d) a ordering parameters for (TiVNbMoHfTaW)₄AlC₃ MAX phase.

FIG. 36. Shows in: FIG. 36 (a) SEM, FIG. 36 (b) SIMS composition, FIG. 36 (c) XRD results, and FIG. 36 (d) a ordering parameters for (TiVZrNbMoTaW)₄AlC₃ MAX phase.

FIG. 37. Shows in: FIG. 37 (a) SEM, FIG. 37 (b) SIMS composition, FIG. 37 (c) XRD results, and FIG. 37 (d) a ordering parameters for (TiVCrZrNbMoHfTaW)₄AlC₃ MAX phase.

FIG. 38. Shows SEM and EDS mapping image of (TiVCrZrNbMoHfTaW)₄AlC₃ MAX showing all transition metals present in a single grain of MAX.

FIG. 39. Depicts and shows: Composition at each atomic layer in equimolar ordered double transition metal M₄AlC₃ phases of (a) Mo₂Ti₂AlC₃, (b) Mo₂V2AlC₃, and (c) Mo₂Nb₂AlC₃.

FIG. 40. Depicts and shows: XRD patterns of FIG. 40 (a) MAX to MXene synthesis, showing shifting of the (006) peak, which implies interlayer expansion, which is a result of etching and intercalation of water molecules between the gap of M₄C₃ sheets. FIG. 40 (b) XRD of a few select free-standing M₄C₃Tₓ MXene films showing typical diffraction pattern.

FIG. 41. Depicts and shows Electron microscopy images of FIG. 41 (a) single-to-few flake and a FIG. 41 (b) free-standing thin film of (TiVCrZrNbMoHfTaW)₄C₃Tₓ MXene. FIG. 41 (c-1) EDS mapping of the free-standing thin film as shown in panel FIG. 41 b showing that the MXene film indeed contains Ti, V, Cr, Zr, Nb, Mo, Hf, Ta, W, and trace contents of Al.

FIG. 42. Depicts Zeta potential measurements of the investigated compositions of M₄C₃Tₓ MXenes dispersed in water.

FIG. 43. Depicts data of X-ray photoelectron spectroscopy (XPS) deconvolution of a film of (TiVNbW)₄AlC₃.

FIG. 44. Depicts data of X-ray photoelectron spectroscopy (XPS) deconvolution of a film of (TiVNbMoTaW)₄AlC₃

FIG. 45. Depicts data of X-ray photoelectron spectroscopy (XPS) deconvolution of a film of (TiVNbMoHfTaW)₄AlC₃.

FIG. 46. Depicts data of X-ray photoelectron spectroscopy (XPS) deconvolution of a film of (TiVCrZrNbHfTaW)₄AlC₃.

FIG. 47. Depicts data of X-ray photoelectron spectroscopy (XPS) deconvolution of a film of (TiVCrZrNbMoHfTaW)₄AlC₃.

FIG. 48. Shows: Surface composition of the investigated MXenes. FIG. 48 (a) Average surface group composition of M₄C₃Tₓ MXenes plotted against the number of transition metals. FIG. 48 (b-c) Breakdown of the contributions to the composition of the surface groups (as shown in panel FIG. 48 a) plotted which element is responsible for MXenes containing 2-9 transition metals.

FIG. 49. Shows: The formation energy of FIG. 49 (a) bare vs. FIG. 49 (b) O terminated vs.

FIG. 49 (c) F terminated MXenes with different pairs of transition metals. Energy is calculated relative to the unary MXenes. Interestingly, we note that the trend in lowest energy ordered configurations for O and F terminated double transition metal MXenes is opposite to that established in the MAX phases.

FIG. 50. Shows: Calculated ΔE_{f} between the O and F terminated ordered configurations of the double transition metal MXenes to determine termination preference with respect to metal identities.

FIG. 51. Depicts and Shows in: FIG. 51 (a) Data from FIG. 3b and FIG. 49 shown aside the data from FIG. 51 (b-c) FIG. 3c-d of the main text for side-by-side visual comparability.

FIG. 52. Shows in: FIG. 52 (a) Intensity of M-O, FIG. 52 (b) M-F, FIG. 52 (c) C—O, and FIG. 52 (d) C—F vibrations in FTIR. The dotted lines are simply guides for the eye. The decreasing intensity of the C—O and C—F vibrations indicate a potential change in electron density around C. Dotted lines shown in FIG. 52 (c) and FIG. 52 (d) are guides to the eye and are not definitive trend lines.

FIG. 53. Depicts Normalized Raman spectra of MXene sheets with various compositions on gold-coated glass substrates (peak at ˜490 cm⁻¹). MXenes with FIG. 53 (a) four different transition metals (Ti, V, Nb, Mo), FIG. 53 (b) five (Ti, V, Nb, Mo, W), FIG. 53 (c) six (Ti, V, Nb, Mo, Ta, W), and FIG. 53 (d) seven, including (Ti, V, Cr, Nb, Mo, Ta, W).

FIG. 54. Depicts Normalized Raman spectra from 100 to 800 cm⁻¹ of for various MXene flake compositions deposited on glass substrates (peak at −490 cm⁻¹). Raman signal from FIG. 54 (a) the glass substrate alone, FIG. 54 (b) with ordered Mo and Nb, FIG. 54 (c) with four transition metals (Ti, V, Zr, W), and FIG. 54 (d) with nine metals (Ti, V, Cr, Zr, Nb, Mo, Hf, Ta, W).

FIG. 55. Depicts Normalized Raman spectra from 100 to 350 cm⁻¹ of various MXene flake compositions drop cast on glass substrates. FIG. 55 (a) Raman signal obtained with only the glass substrate, and FIG. 55 (b) with patterned transition metal Mo and Nb, FIG. 55 (c) with 4 different transition metal Ti, V, Zr, W; FIG. 55 (d) with 9, Ti, V, Cr, Zr, Nb, Mo, Hf, Ta, W.

FIG. 56. Depicts The low-intensity Raman patterns can be explained by the lack of a strong absorbance peak UV-Vis-NIR spectra of ˜0.1 mg/mL aqueous suspensions of M₄C₃Tₓ comprised of FIG. 56 (a) 2 transition metals (except Mo₂Ti₂C₃Tₓ at −420 nm), FIG. 56 (b) 4 transition metals, FIG. 56 (c) 5 transition metals, FIG. 56 (d) 6 transition metals, FIG. 56 (e) 7 transition metals, and FIG. 56 (f) 8-9 transition metals.

FIG. 57. Depicts in: FIG. 57 (a) Resistivity of all of the investigated M₄C₃Tₓ MXene films plotted against the total number of transition metals and FIG. 57 (b) the clear linear dependence between V and I of a few investigated M₄C₃Tₓ MXene films.

FIG. 58. Bar chart showing that MXenes containing Cr are typically nearly an order of magnitude higher in electrical resistivity.

FIG. 59. Depicts Flake size measurements as measured using dynamic light scattering (dynamic light scattering) of the investigated compositions of M₄C₃Tₓ MXenes dispersed in water.

FIG. 60. Shows Example images using atomic force microscopy (AFM) images of some of the investigated compositions of M₄C₃Tₓ MXenes deposited on Si.

FIG. 61. Depicts in: FIG. 61 (a-b) Electrical resistivity and FIG. 61 (c-d) IR emissivity plotted against FIG. 61 (a, c) the difference in ordering between Mo and Ti and FIG. 61 (b, d) the difference in valence electron concentrations (VEC) in the M′ and M″ layers. The resistivity and IR emissivity is taken from FIG. 3 of the main text and the ordering and VEC calculations are derived from the SIMS for each phase. The arrow and dotted line are guides to the eye and are not fitted to the data.

### DETAILED DESCRIPTION

### A. Definitions

The following description of the disclosed nanocube structures, components, construction and methods of use are provided as an enabling teaching of the invention in its best, currently known embodiment. Those of ordinary skill in the art will recognize and understand that changes can be made to the various aspects of the disclosed nanocage structures, methods of making, and methods of use, while still obtaining the beneficial results of the disclosed nanocube structures and methods. It will also be apparent that some of the desired benefits of the disclosed nanocube structures and methods can be obtained by selecting some of the features of the disclosed nanocube structures and methods without utilizing other features. Those who work in the art will recognize that many modifications and adaptations to the disclosed compositions, structures and methods are possible and can even be desirable in certain circumstances and form a part of the disclosure.

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

As used in the specification and the appended claims, the singular forms “a”, “an” and “the” include plural forms unless the context clearly dictates otherwise.

As used in the specification and in the claims, the term “comprising” can include the aspects of “consisting of” and “consisting essentially of”.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or cannot occur, and that the description includes instances where said event or circumstance occurs and instances where it does not.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Acros Organics (Morris Plains, N.J.), Strem Chemicals (Newburyport, MA), Fisher Scientific (Pittsburgh, Pa.), or Sigma-Aldrich Chemical Co. (Burlington, MA) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and supplemental volumes (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of embodiments described in the specification.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Examples

### Effect of Enthalpy and Entropy on the Order-to-Disorder Transition in MAX Phases

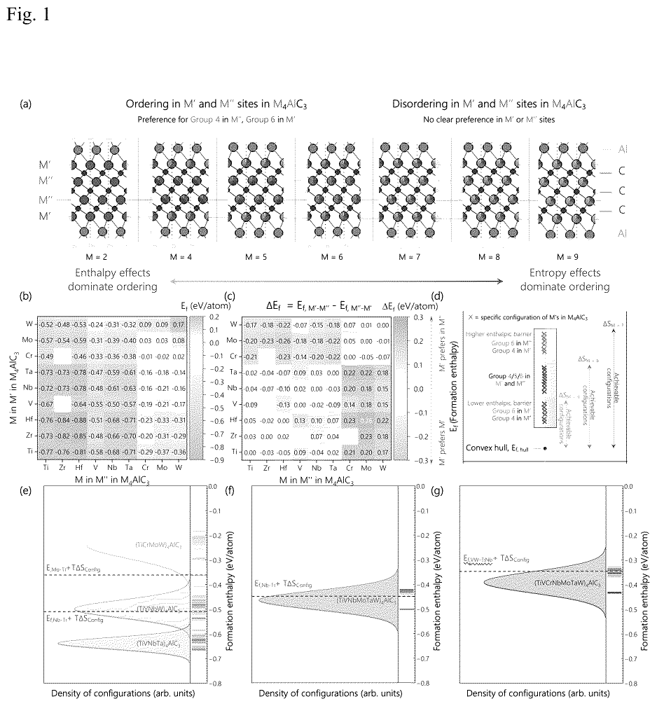

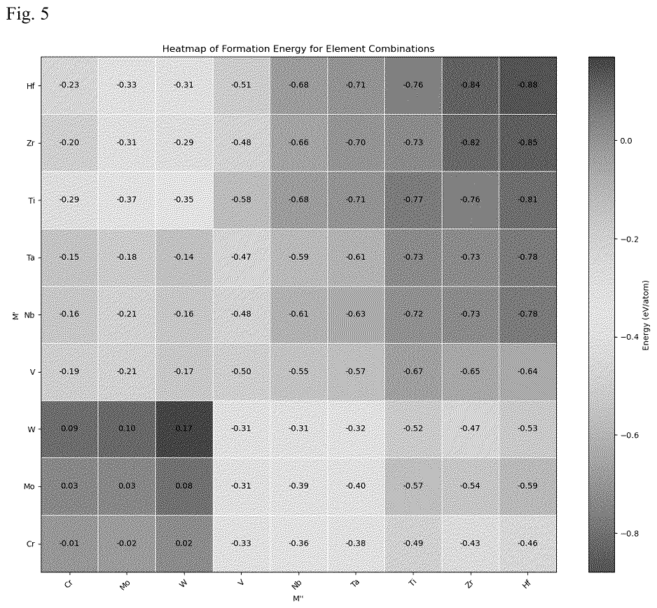

To gain insight into the competition between enthalpy and entropy toward the order-disorder transition in high-entropy MAX phases (FIG. 1a), we first used density functional theory (DFT). To first understand the M′ vs. M″ preference for different transition metals in the M₄AlC₃ MAX phase, we first built a symmetric model considering a pair (M₁ and M₂) of transition metals in either M′ or M″ layers (M₁-M₂-M₂-M₁) for all the possible combinations (from 2 to 9 elements) (FIG. 4, Figure S1). The graphic depicted in FIG. 5 (FI 2) shows the formation energy (E_{f}) of these configurations, the calculation details are described below.

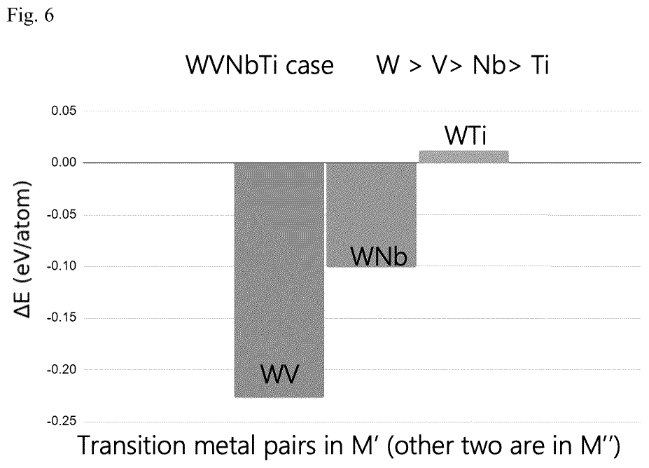

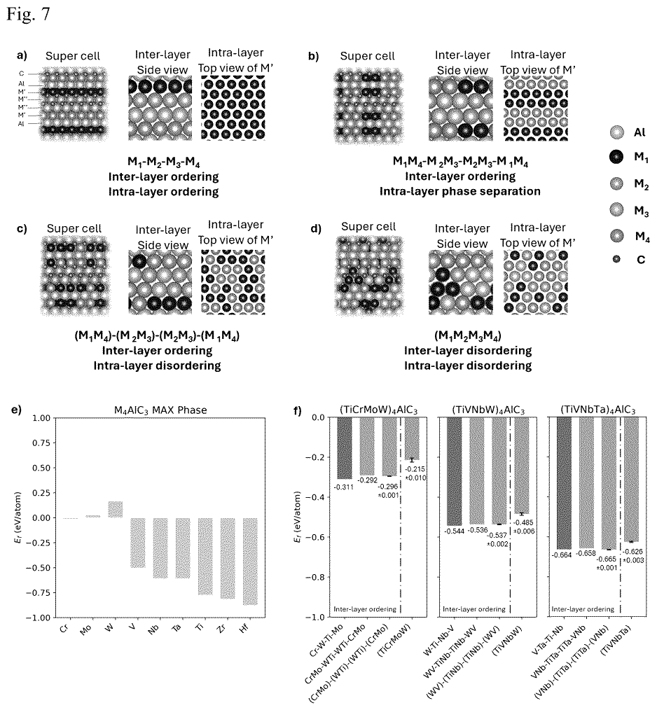

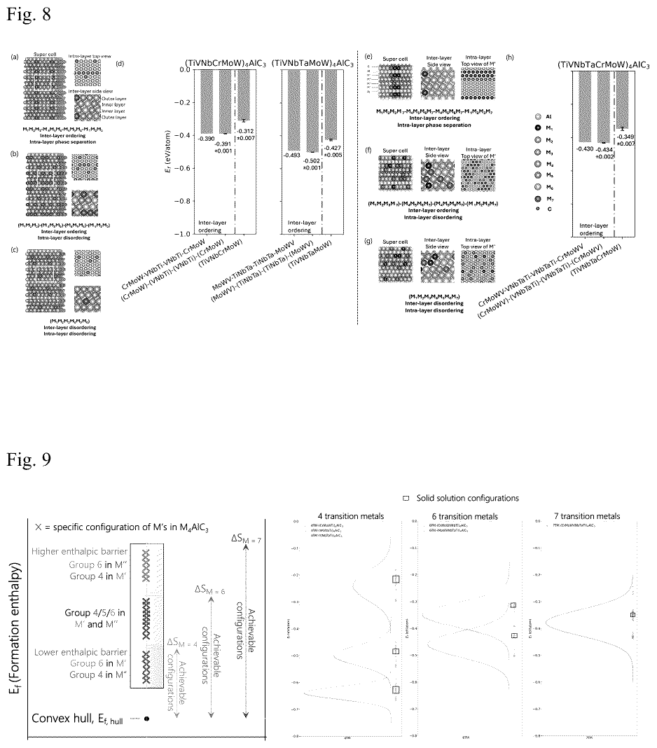

After calculating these formation energies, we next used the difference in the formation energy (ΔE_{f}) between these structures with two given transition metals in either M′ and M″ sites to observe the enthalpic preference of the transition metals to the various lattice sites (FIG. 1b). We focused on identifying the preference for an M to order in separate transition metal planes as we found it has a higher effect on the formation energy than any in-plane order (FIG. 7-8; Figure S4-S5). Trend-wise, we observed that the M′ preference is Cr>Mo>W>V>Nb>Ta>Ti>Zr>Hf (inverse for M″ preference), which agrees with previous works (28). This preference is still present in M₄AlC₃ structures with >2 transition metals FIG. 6 (Figure S3).

In MAX phases, in addition to interlayer ordering, where is an outer layer preference for certain TMs, intra-layer ordering may also take place and influence material properties. Therefore, we also compared the effect of inter-layer ordering and intra-layer ordering on E_{f}. First, we built four models (FIG. 7a-d; Figure S4a-d) for the (TiCrMoW)₄AlC₃, (TiWVNb)₄AlC₃ and (TiVNbTa)₄AlC₃ systems, ranging from fully ordered to fully disordered condition, and calculated their E_{f} (Figure S4f). The configurations with interlayer ordering and varying degrees of intralayer ordering (Figure S4a-c) consistently exhibit the lower E_{f} compared to configurations with both inter-layer and intra-layer disordering (Figure S4d). Thus, the effect of intra-layer ordering on E_{f} is significantly less than the inter-layer ordering. Additionally, there is no significant difference in E observed when only degrees of intra-layer ordering vary from fully ordered (Figure S4a) to phase-separated (Figure S4b) to disordered (Figure S4c). For (TiCrMoW)₄AlC₃ and (TiWVNb)₄AlC₃ systems, the most favorable configuration a fully ordered configuration with certain TM distribution (Figure S4a) which E_{f} values of −0.311 eV atom⁻¹ and −0.544 eV atom⁻¹, respectively. However, for (TiVNbTa)₄AlC₃ system, the most favorable configuration is intra-layer disordered configuration (Figure S4c), with E=−0.665±0.001 eV atom⁻¹. Systems containing elements with a stronger outer-layer preference are more likely to favor fully ordered configurations.

We also explored the 6-TM and the 7-TM MAX systems to further understand the effect of inter-layer ordering and intra-layer ordering on E_{f}. Three models were created: inter-layer ordering with intra-layer phase separation (FIG. 8a; Figure S5a), inter-layer ordering with intra-layer disordering (FIG. 8b; Figure S5b) and full disordering (FIG. 8c; Figure S5c). The E_{f} values, shown in Figure S5d (FIG. 8d), revealed the same conclusion as 4 TMs MAX systems: inter-layer ordering has more effect on E_{f} than intra-layer ordering.

Next, we evaluated the enthalpy vs. entropy contributions to the preference of different transition metals in the M′ and M″ sites in M₄AlC₃ MAX phases. To do so, we implemented a model proposed by Curtarolo's team (18), which showed that the ability of entropy to stabilize any given configuration of multiple elements within a single structure depends on the difference between the formation enthalpy of that given configuration compared to the hull formation energy (a single element system, for example), which we refer to as the enthalpic barrier. In our work, we propose that even low to medium configurational entropy contributions can stabilize the configurations with low enthalpic barriers (FIG. 9; Figure S6), which we believe can be experimentally observed as short-range ordering within entropy-stabilized systems. Based on this argument, we then propose to describe the “high-entropy” moniker as the point at which all configurations in a given structure, regardless of the enthalpic barriers for any given configuration, can be energetically stabilized by entropy.

To evaluate this argument, we used our model for short-range order given the clear enthalpic preference for transition metal arrangement in the M₄AlC₃ MAX phase structure. As shown in FIG. 1e, we first analyzed the M₄AlC₃ MAX phase structures with 4 transition metals: (TiVNbTa)₄AlC₃, (TiVNbW)₄AlC₃, and (TiCrMoW)₄AlC₃. Broadly, we find when the preference for order (labeled “ordered”) is matched (FIG. 7-9; Figure S4-6), the lowest formation energies are achieved. For example, when V and W occupy only M′ sites and Ti and Nb occupy only M″ sites in (TiVNbW)₄AlC₃, the formation energy is −0.544±0.001 eV/atom. In contrast, if Ti and Nb occupy only M′ sites and V and W occupy only M″ sites (labeled “inverse ordered”), the formation energy is −0.430±0.001 eV/atom. Similarly, solid solution occupancies of Ti and Nb in M′ and M″ sites have a higher formation energy of −0.485±0.006 eV/atom for (TiVNbW)₄AlC₃ than the ordered configuration.

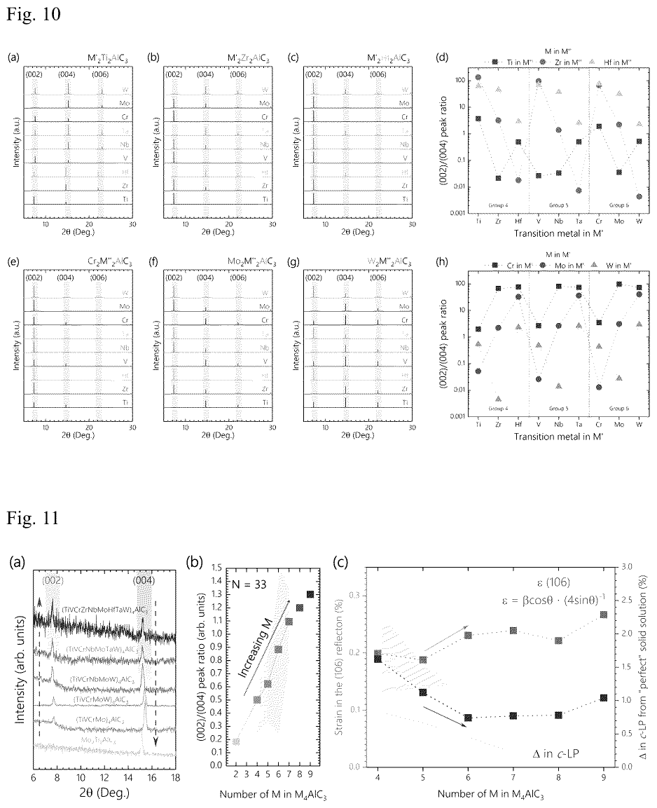

Additionally, we found that group 6 elements increased the distribution of the energy barriers due to the energetic preference for group 6 elements to occupy M′ sites (FIG. 9; Figure S6). Broadly, this suggests that MAX phases containing mixtures without group 6 elements are more energetically favored. However, we found that the formation energy of MAX phases containing group 6 elements was lowered when an increasing number of transition metals were present, which potentially provides an avenue as a design tool to include more group 6 elements in the From another perspective, if we aim to retain group 6 elements within the system for better HER performance, introducing increasing amounts of other transition metal (TM) elements can also enhance the system's stability and the barrier between ordering and disordering structures (FIG. 9c; Figure S6-c), thereby facilitating the transition from an ordered to a disordered structure. Due to the extensive computational demand, it is not feasible to simulate all possible compositions. Therefore, based on analyzing the contributions of enthalpy and entropy across several compositions (FIG. 10; Figure S7), we predict that the transition from order to disorder occurs when a seventh element is introduced (FIG. 1c).

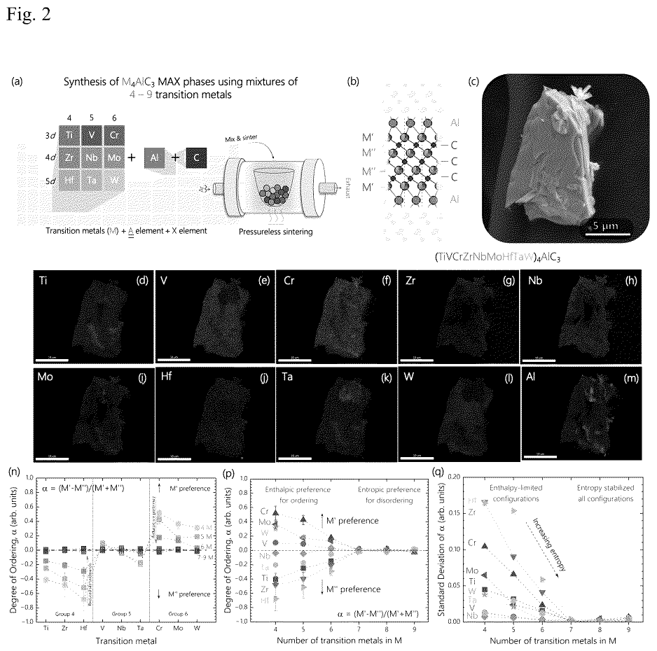

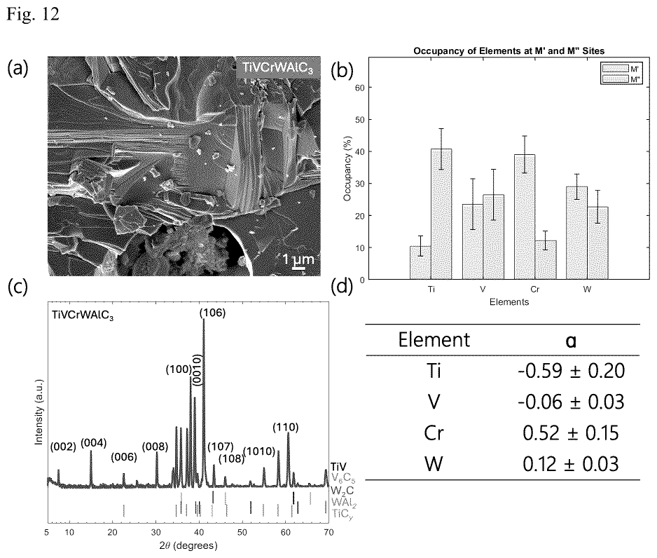

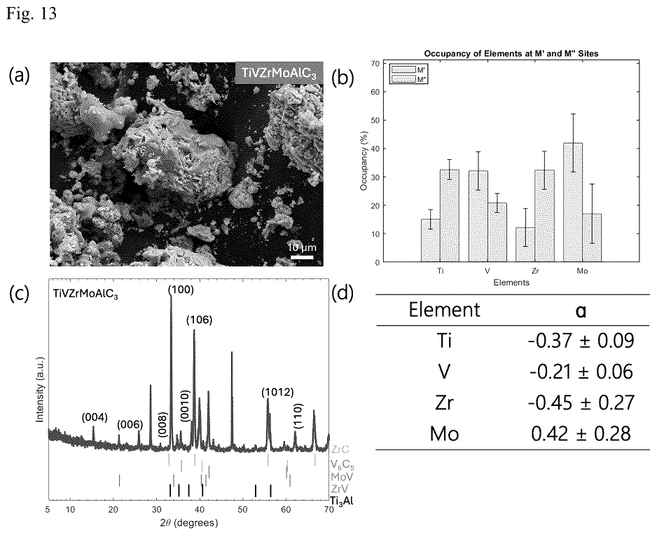

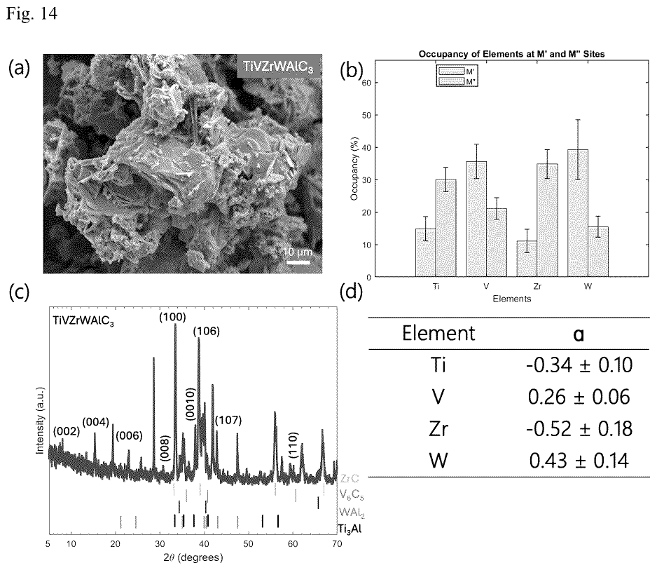

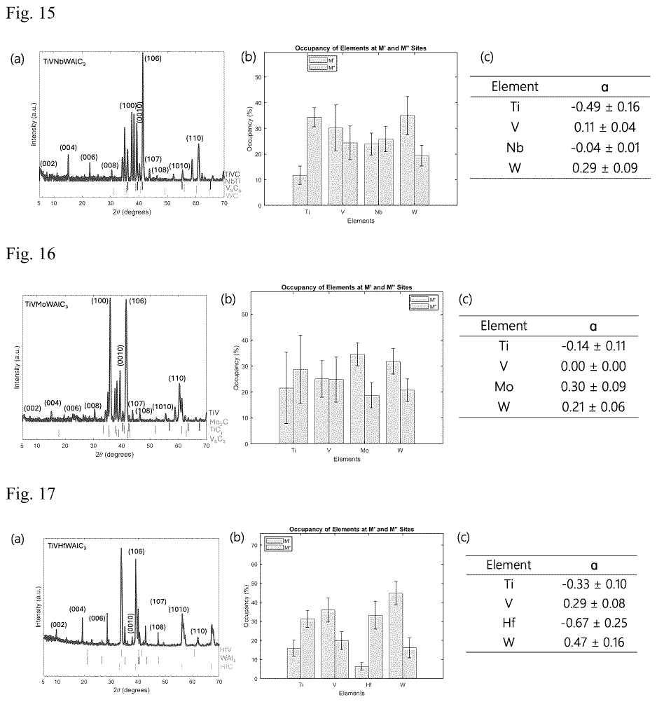

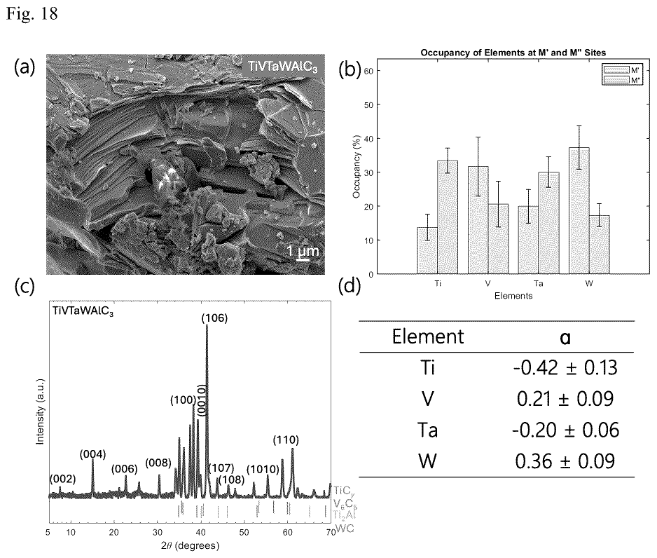

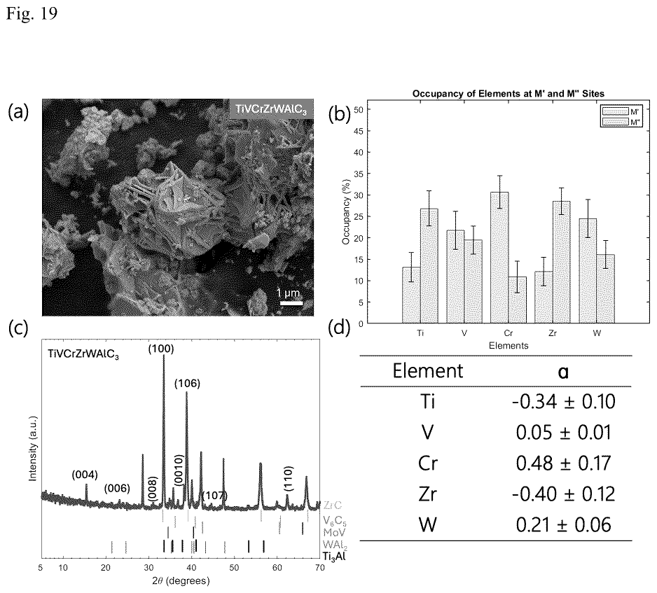

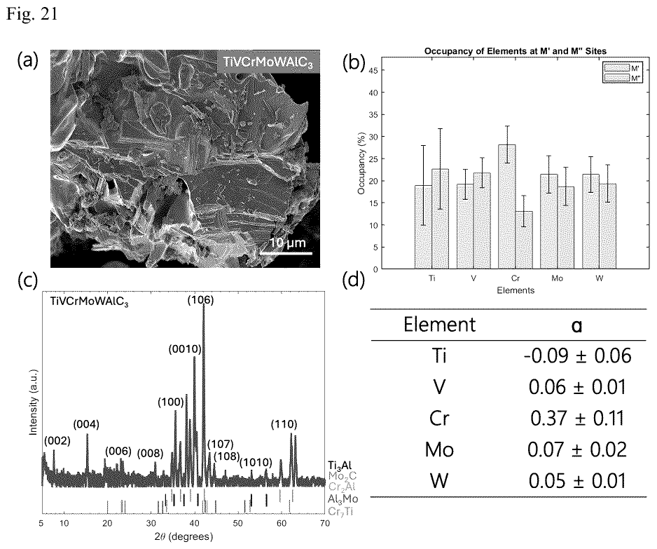

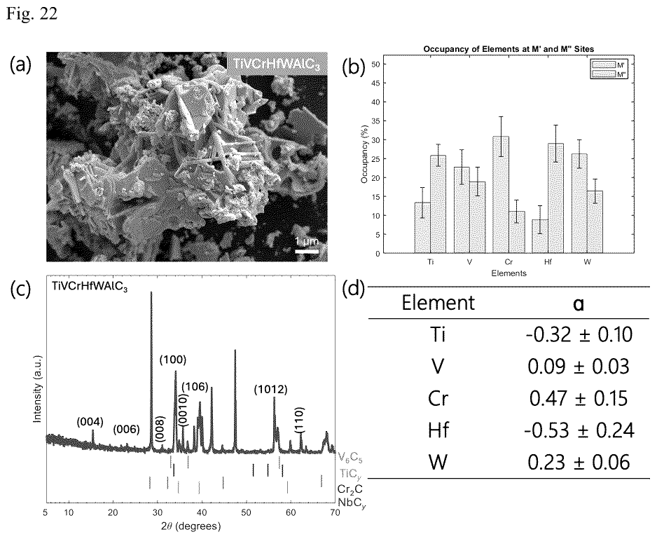

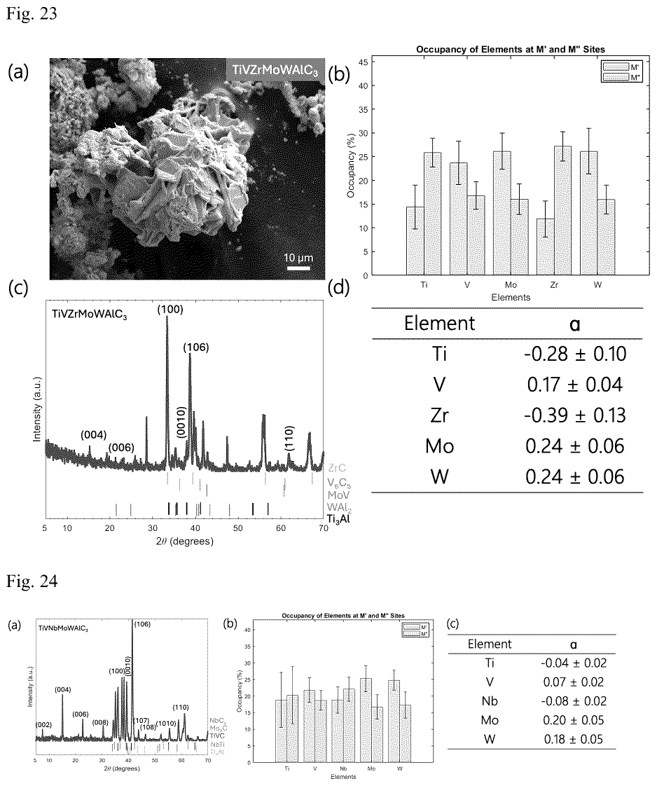

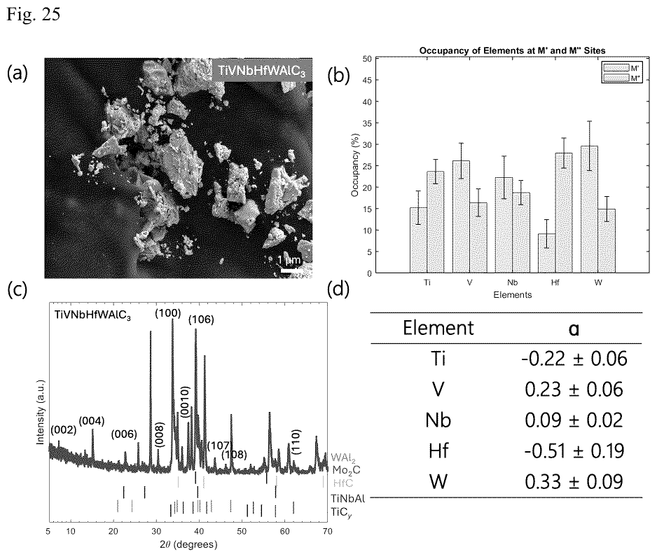

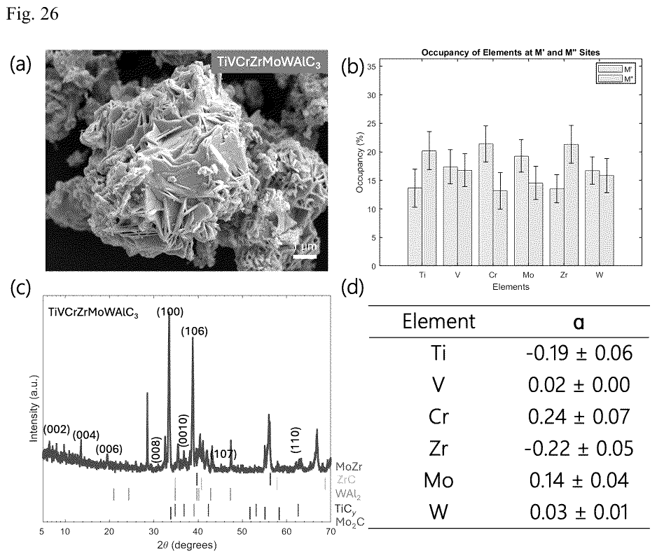

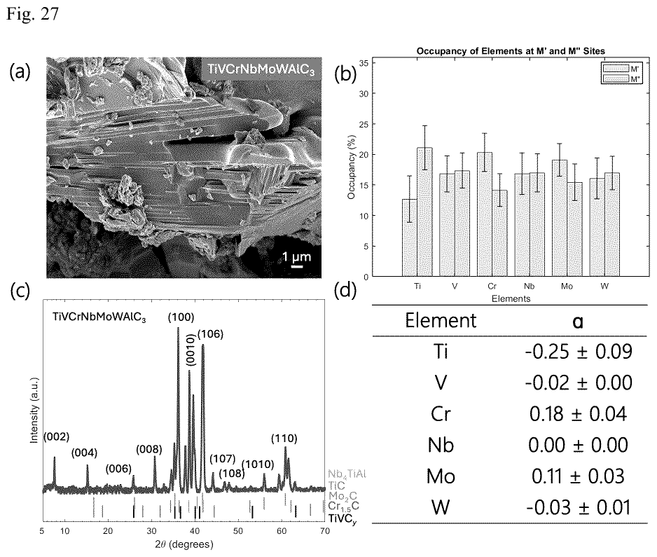

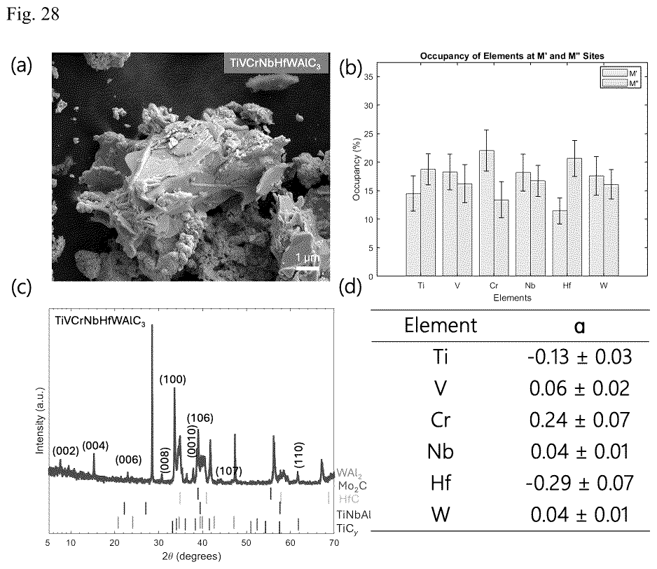

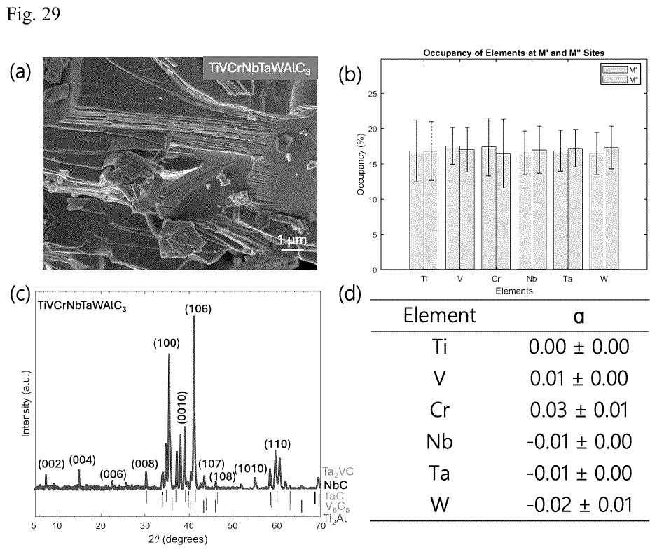

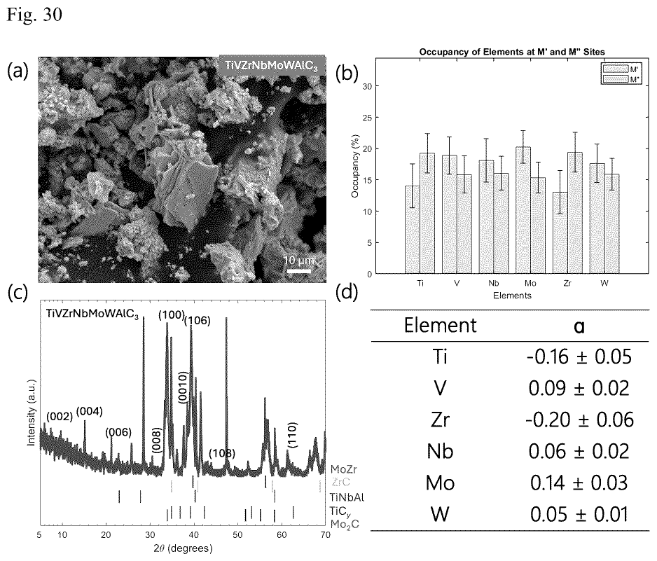

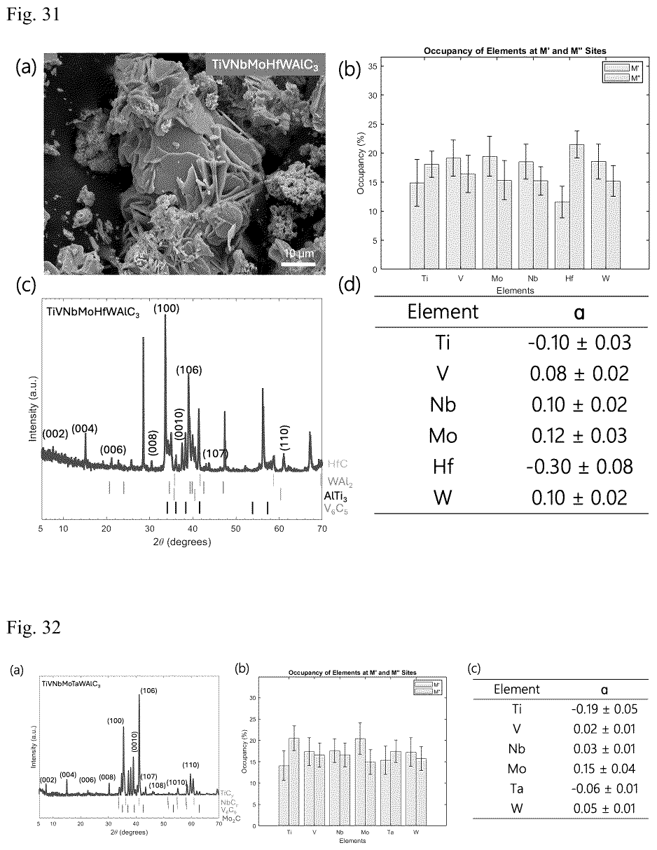

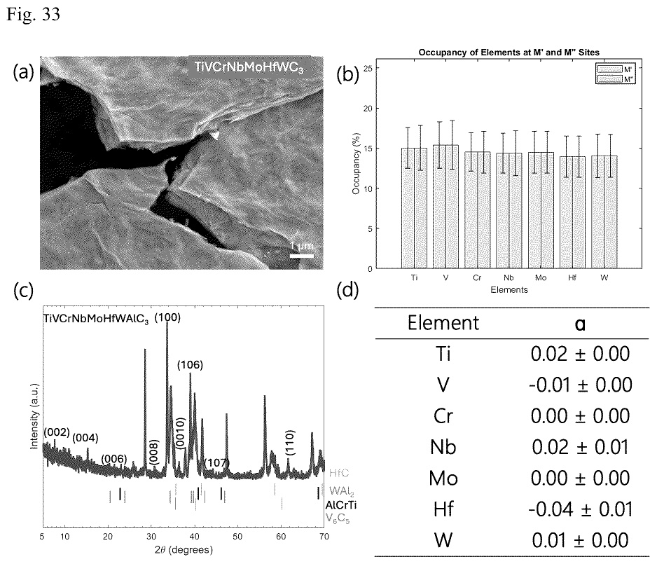

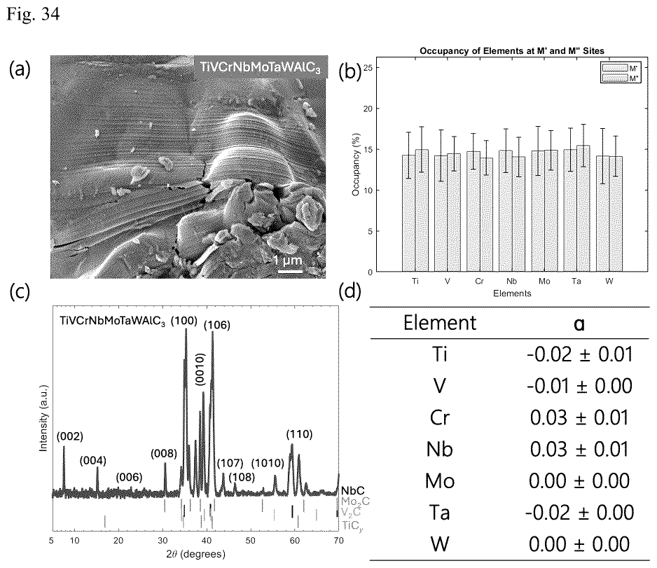

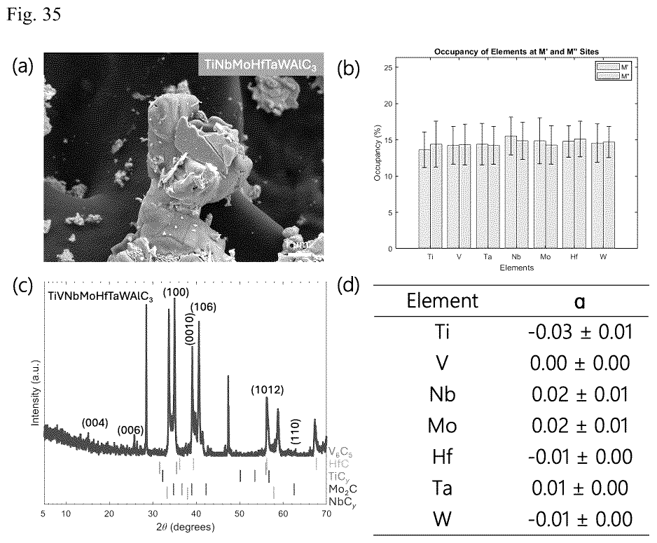

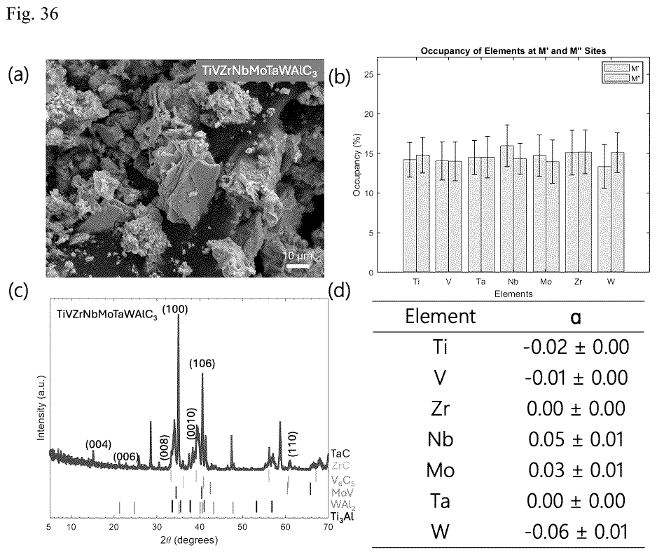

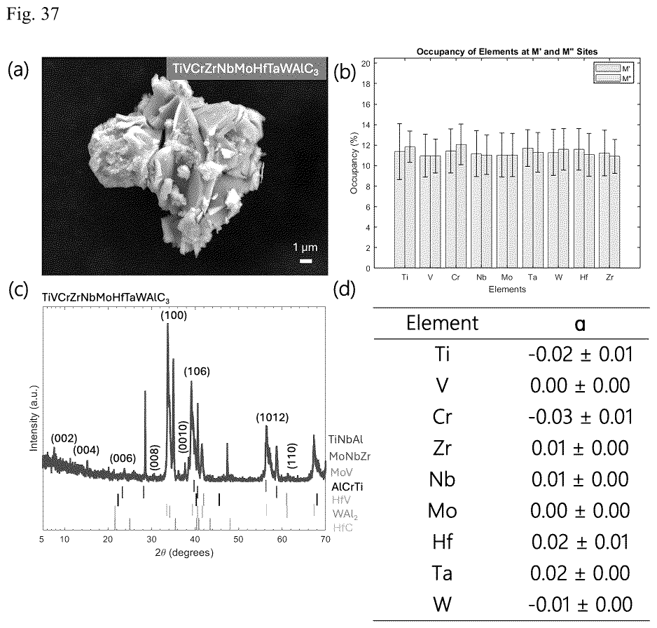

With the gained knowledge from the energetic perspective, we next experimentally synthesized M₄AlC₃ MAX phases containing combinations of 2 and 4-9 Group 4, 5, and 6 transition metals (FIG. 2a-b). Synthesis and other details for the MAX phases are as described. To see if we experimentally observed ordering in our M₄AlC₃ MAX phases, we first analyzed the x-ray diffraction (XRD) patterns (FIG. 10-11; Figure S7-8). All MAX phase characterization and analysis for each phase reported in this study can be found in Figures S9-34 (FIG. 12-37). FIG. 2c shows the scanning electron microscopy (SEM) image for (TiVCrZrNbMoHfTaW)₄AlC₃ shows a layered grain structure phases (33) and the energy dispersive x-ray spectroscopy (EDS) shows the grain contains all 9 Ti, V, Cr, Zr, Nb, Mo, Hf, Ta, and W (Figure S35). Although the XRD data gave us some insight into the ordering, we believed it would be difficult to accurately compare transition metals with very similar x-ray scattering behavior (i.e., Ti vs. V vs. Cr, Zr vs. Nb vs. Mo, Hf vs. Ta vs. W), so we focused on using an atomic-layer resolved dynamic secondary ion mass spectrometry (SIMS) method (34-36).

### C. Materials and Methods

### MAX Phase Synthesis

We synthesized our MAX phases using M:Al:C ratios of 4:2:2.7 of elemental powders, where the molar ratio of each individual transition metal was calculated by dividing 4 by the intended total number of transition metals (1 mol for 4 transition metals, 0.8 mol for 5, etc.). The mixed metal powders were sourced from Alfa-Aesar at a −325 mesh size while the carbon was sourced from amorphous calcined coke (Alfa-Aesar). The powders were ball-milled using a rolling jar mill by putting the powders in high-density polyethylene (HDPE) bottles with zirconia milling media for 18 h. After mixing, the powders were then placed into alumina crucibles and fired in a tube furnace (Across International) at 1600° C. for 4 h under a flow rate of 200 mL/min of Ar. After firing, the resultant MAX blocks were milled into a fine powder and sieved to a particle size of <71 m for analysis.

### MXene Synthesis

To synthesize the MXenes, each MAX phase was slowly added (˜1 min) into a HDPE bottle containing a stirring (300 RPM) mixture of 12 mL hydrofluoric acid (48 wt % stock, Millipore Sigma) and 8 mL hydrochloric acid (12 M stock, Fisher Scientific) per gram of MAX held at 35° C. for 4 days to remove the Al between the layers form the MAX to form multi-layer MXene. After etching, the acidic solution with multi-layer MXene was washed with water by repeated centrifugation (addition of water, centrifuged 3000 RCF for 1 min, decanted, re-addition of water, redispersion of the powder) until the pH was >6. After neutralizing the acid, 5 wt % of tetramethylammonium hydroxide (Fisher Scientific) at a ratio of 10 mL/g was used to disperse the MXene and allowed to stir (300 RPM) at room temperature for 2 h. After 2 h, the solution was similarly washed (now centrifuged at >22,000 RCF for 5 min) until the pH was <8. Afterwards, the clay was redispersed and centrifuged at 500 RCF for 15 min to yield single-to-few layer MXenes solutions. To gain single-to-few layer flake free-standing films, we vacuum filtered ˜40 mg of this solution at a concentration of ˜2-3 mg/mL on Celgard filter paper.

### X-Ray Diffraction

To measure the crystallographic characteristics of the MAX and MXenes, we measured the x-ray diffraction pattern of these phases from 5-75° 2θ at a scan rate of 5° 2θ/step for a dwell time of 30 s/step using a Bruker D8 Discover diffractometer paired with a Vantec area detector with a x-ray source of monochromatic Cu Kα. For the lattice constants and strain analysis of the MAX phases, roughly ˜10 wt % of a 140 mesh Si was added to the powder, where the Si was used to correct for instrument error in both the peak positions and peak width.

For comparison of the lattice constants using Vegard's law, we used the theoretical lattice constants of the MAX phases (with 1-2% error from reported phases) after relaxation in density functional theory simulations to calculate the expected lattice constants for solid solution occupancies. For strain calculations, after the Williamson-Hall method was used, which can be calculated from below:

$${β}_{sample} = {β}_{size} + {β}_{strain} = \frac{K λ}{L cos θ} + 4 ε \frac{sin θ}{cos θ}$$

Where βₛₐₘₚₗₑ refers to the full-width half-max of the (106) peak of MAX, β_{size} is the contribution to the peak broadening from sample size effects, θ is the corrected peak position of the (106) peak from the XRD pattern, and βₛₜᵣₐᵢₙ was assumed to be due to interior distortion in the lattice of the MAX phase. In this calculation, β_{size} was assumed to be negligible as our MAX phases were sufficiently large (20-70 gm) compared to the x-ray wavelength (0.15406 nm). Therefore, the final equation to measure strain became:

$$ε = \frac{{β}_{strain} cos q}{4 sin θ}$$

Scanning Electron Microscopy and Energy Dispersive x-Ray Spectroscopy

For scanning electron microscopy measurements, a JEOL 4800f field emission scanning electron microscope paired with an EDAX Octane Super Detector with associated EDAX TEAM software was used. Typically, we used an acceleration voltage of 20 kV for imaging and energy dispersive x-ray spectroscopy measurements. For EDS point scans, grains of MAX were identified and taken at 1000000× magnification by dwelling for 30 s, while maps were completed around 3000-5000× magnification at a step size of ˜0.1 m with a dwell of 500 s per step and repeated over the area 60-100 times.

### X-Ray Photoelectron Spectroscopy

X-ray photoelectron spectroscopy (XPS) spectra were collected for each material on a Thermo K-Alpha XPS system with a spot size of 400 μm and a resolution of 0.1 eV. All spectra were processed using Thermo Advantage, which is a software package provided through ThermoScientific.

### Secondary Ion Mass Spectrometry

SIMS experiments were performed using a CAMECA IMS SC Ultra instrument. Cs⁺ primary ions with ultra-low impact energy (100 eV) and high angle of incident (75°) were used. To achieve atomic depth resolution several modifications of the measurement procedures were introduced, such ion polishing, extraction parameters optimization, super-cycling, and advanced beam positioning.

For the M′ and M″ occupancies, the percentage of each element was averaged across 37 M planes in the M₄AlC₃ structure. To calculate the degree of ordering term, a, we used the following equation:

$$α = \frac{{M}^{′} - {M}^{″}}{{M}^{′} + {M}^{′}}$$

Where M′ and M″ represent the content of each M element in the M′ and M″ layers, respectively. All standard deviations, both in this SIMS averaging and in this study broadly, were propagated using the root mean square method.

### Raman Spectroscopy

To perform Raman spectroscopy on MXene, MXene sheets were prepared on gold-coated glass substrates to reduce unwanted signals from the substrate and provide clear Raman signals from the MXene. The Raman spectra were recorded using a HORIBA LabRAM HR800 Raman Spectrometer (with an instrument spectral uncertainty of ±0.27 cm⁻¹) with a 532 nm excitation laser. The beam was focused through a 100× objective (Olympus MPlan 100×, 0.90NA, ˜0.5 μm spot size) for higher spatial resolution. Raman measurements were performed on surface of the MXene sheets, and each spectrum was normalized utilizing the Standard Normal Variate (SNV) method, facilitating consistent comparison of Raman signals across different MXene compositions. A sharp peak near 500 cm⁻¹ is observed due to the glass substrate underneath the MXene, as reported in previous studies where glass contributes characteristic peaks. Although efforts were made to minimize substrate influences, it is challenging to completely isolate the Raman signal from the MXenes since it is relatively weak.

### Density Functional Theory

Geometry optimization and Energy calculations of the various 413 MAX configurations were performed using Density functional theory (DFT) implemented in the Vienna ab initio Simulation Package (VASP). The exchange-correlation potential with the generalized gradient approximation (GGA) of the Perdew-Burke-Ernzerhof (PBE) and the Projector-Augmented Wave (PAW) potentials were used. The DFT-D3 method is employed to account for the effect of van der Waals interaction. Plane-wave cut-offs were set to 500 eV. All atomic coordinates were fully relaxed until the absolute value of the total energy is less than 10⁻⁶ eV per atom and atomic force is less than 0.01 eV Å⁻¹. Spin polarized calculations are performed in system which magnetic moments cannot be negligible. A 3×3×1 Γ-centered point is used for the supercell, transition metal (TM) elements have equal atomic concentration in supercell. All the structures are visualized in the VESTA code.

Formation energy (E_{f}) of various configurations for different systems is defined as:

$$( Equation 1 )$$

$${E}_{f} ( eV / atom ) = \frac{{E}_{MAX} - \sum ( N ( {M}_{i} ) \times μ ( {M}_{i} ) ) - N ( Al ) \times μ ( Al ) - N ( C ) \times μ ( C )}{\sum N ( {M}_{i} ) + N ( Al ) + N ( C )}$$

where E_{MAX} is the energy of supercell for various configuration, calculated by DFT, N(Mᵢ) is the number of atoms for each TM element in supercell, μ(Mᵢ) is the chemical potential of one atom for each TM element in supercell, N(Al) and N(C) are the number of atoms for Al and C, μ(Al) and μ(C) are the chemical potential of one aluminum atom and one carbon atom (Table 1). TMs in all systems have equal atomic concentration which is 64 for each TM element in supercell.

TABLE 1
Crystal structure and chemical potential for various elements

| Element | Stable crystal structure | Chemical potential (μ, eV/atom) |
|---|---|---|
| C | α-graphite | −9.37 |
| Al | FCC (Fm3m) | −4.09 |
| Cr | BCC (Im3m) | −10.00 |
| Mo | BCC (Im3m) | −11.67 |
| W | BCC (Im3m) | −13.72 |
| V | BCC (Im3m) | −9.65 |
| Nb | BCC (Im3m) | −10.96 |
| Ta | BCC (Im3m) | −12.53 |
| Ti | HCP (P63/mmc) | −8.39 |
| Zr | HCP (P63/mmc) | −9.06 |
| Hf | HCP (P63/mmc) | −10.38 |

In our 413 MAX system, the configuration entropy (S_{conf.}) only arises from the different distributions of various TMs across 4 TM layers. The aluminum and carbon layers do not contribute to S_{conf.}, S_{conf.} of a system is estimated by

$$△ {S}_{mix , non - ideal} = - nR {\sum }_{i = 1}^{k} {x}_{i} ( ln {γ}_{i} + ln {x}_{i} ) \qquad ( Equation 2 )$$

TABLE 2
Configurations entropy (S_{conf.}) for the inter-layer
ordering and disordering in 4-TM6-TM and 7-TM systems

| System | S_{conf.} |
|---|---|
| 4TM | 1.2 × 10⁻⁴ |
| 6TM | 1.5 × 10⁻⁴ |
| 7TM | 1.7 × 10⁻⁴ |

To evaluate the competition between ordering and disordering in different systems, we estimate the formation free energy (ΔG_{f}) by:

$$Δ {G}_{f} ( eV / atom ) = Δ 〈 {E}_{f} 〉 - T Δ {S}_{conf .} \qquad ( Equation 3 )$$

where Δ [symbol] E_{f} [symbol] is the difference in the average formation energy between disordered and ordered [symbol] configurations, and T is the temperature in Kelvin (K).

### Electrical Measurements

The films were contacted with silver paste and measured in a 2-point configuration in ambient conditions. To run the current-voltage characteristics we made use of a Micromanipulator 4060 Probe Station, equipped with micromanipulators connected to a Keithley system. The channel length (l) and width (W) vary from sample to sample as well as the film thickness (t), measured with a Keyence optical microscope (Keyence 3D Optical Profilometer VR-6000 series). The resistance value, extrapolated from the slope of the linear I-V curves (SI), was normalized by the channel 1, W and t to calculate the material resistivity. Four sample for each film and batch were measured to obtain the reported statistics.

### IR Emissivity and Reflectivity Measurements

The high-entropy MXene samples were prepared as thin freestanding films. The surfaces of the samples would need to be smooth and clean to ensure accurate reflectivity measurements. A gold-coated glass slide was used as a reference material. Gold is an excellent reflector of infrared radiation, and its reflectivity is well known. The 10Spec accessory was used to measure the reflectivity of the gold-coated reference at a 10-degree angle of incidence across the wavelength range of 1 to 25 micrometers. Each MXene sample was placed in the 10Spec accessory, and its reflectivity was measured at a 10-degree angle of incidence across the same wavelength range (1 to 25 micrometers). The spectrometer connected to the 10Spec accessory recorded the intensity of the reflected infrared radiation from both the reference and the MXene samples. The reflectivity of each MXene sample was calculated by comparing the intensity of the reflected radiation from the sample to the intensity of the reflected radiation from the gold-coated reference. The emissivity of each MXene sample was calculated using the simple conversion formula: where ε is emissivity and R is reflectivity. This formula neglects absorptivity contribution as all samples were non-transparent.

$$ε = 1 - R$$

The 10Spec accessory illuminates the sample with a collimated (parallel) beam of infrared radiation at a 10-degree angle of incidence. This controlled angle ensures that the specular reflectance (reflection at the same angle as the incident beam) is measured accurately. The 10Spec is specifically designed to measure specular reflectance, which is the reflection of radiation from a smooth surface at a definite angle. This contrasts with diffuse reflectance, which is the scattering of radiation in many directions. The 10Spec is compatible with various FTIR spectrometers, which are commonly used to measure infrared spectra. The gold-coated reference serves as a calibration standard. By measuring the reflectivity of the known reference, the spectrometer can be calibrated to accurately measure the reflectivity of the MXene samples. Using a highly reflective reference like gold helps to improve the accuracy of the reflectivity measurements, especially for low-reflectivity samples.

### Fourier Transmission Infrared (FTIR) Spectroscopy

Fourier Transform Infrared (FTIR) spectroscopy was employed to characterize the surface terminations of the synthesized MXenes. Attenuated Total Reflectance (ATR) FTIR measurements were performed on free-standing MXene films. The films were directly placed on the ATR crystal, and the spectra were recorded in the range of 2000-400 cm⁻¹. The resolution was set to 4 cm-1 with 14 a total number of scans 25-point smoothing was applied, followed by offset correction normalization as well as concave rubberband correction

### IR Emissivity Data Analysis

Observed trends—decreasing emissivity: as more metals are added to the MXene (from M2 to M6), the emissivity consistently decreases across the infrared spectrum (1-25 micrometers). It's generally understood that increasing the number of metallic elements in a material tends to increase its electrical conductivity. This is especially true when starting with a purely conductive MXenes like niobium (Nb) based. Emissivity and electrical conductivity are inversely related. Materials with high electrical conductivity tend to have low emissivity, and vice versa. This is because good conductors have a large number of free electrons that can readily absorb and re-emit photons, including those in the infrared range. This efficient energy exchange leads to lower emissivity. As more metals are added to the MXene, there is an essentially an increase in the number of free electrons available. This enhances the material's ability to absorb and re-emit infrared radiation, leading to lower emissivity. Starting with niobium (Nb) based MXene, a relatively low conducting MXene, contributes significantly to this trend. As more metals are added, this further enhances the conductivity, which in turn reduces the emissivity. The decrease in emissivity with increasing metal content suggests that these high-entropy MXenes become better at shielding infrared radiation. This is because they are reflecting more infrared radiation and emitting less. While a precise formula relating emissivity (ε) and resistivity (ρ) can be complex and depend on various factors, a simplified relationship can be derived from the Hagen-Rubens relation: where: ε is the emissivity, ρ is the resistivity, λ is the wavelength.

$$ε = √ ( ρ / λ )$$

Emissivity is proportional to the square root of resistivity: as resistivity decreases (conductivity increases), emissivity also decreases. This simplified formula provides a general trend but might not be accurate for all materials and conditions. Factors like temperature, surface conditions, and the complex electronic structure of high-entropy MXenes can influence the precise relationship between emissivity and resistivity. The observations about the trend in emissivity and its correlation with conductivity/resistivity are insightful. This understanding can guide further investigations into the properties and applications of high-entropy MXenes, particularly for uses where infrared shielding or thermal radiation control is desired.

### Deriving the Emissivity Vs Resistivity Equation

The Hagen-Rubens relation describes the reflectivity (R) of a metal at low frequencies as a function of its conductivity (σ). where: R is reflectivity, ε₀ is the permittivity of free space, ω is the angular frequency of the radiation (ω=2πf, where f is the frequency), ρ is the resistivity (ρ=1/σ). Emissivity and Reflectivity For an opaque material in thermal equilibrium, emissivity (ε) and reflectivity (R) are complementary. Substituting the Hagen-Rubens relation into the equation:

$$R \approx 1 - 2 √ ( 2 {ε}_{0} ω ρ ) \\ ε = 1 - R \\ ε = 1 - ( 1 - 2 √ ( 2 {ε}_{0} ω ρ ) ) \\ ε = 2 √ ( 2 {ε}_{0} ω ρ )$$

We assume the metal is a good conductor, meaning that the term 2ε(2ε₀ωρ) is small compared to 1. We also focus on low frequencies (infrared region), where the Hagen-Rubens relation is most applicable. Expressing in terms of wavelength: (where c is the speed of light and λ is the wavelength), we can rewrite the angular frequency. Substituting this into the emissivity equation, by combining the constants into a single proportionality factor, we get the simplified formula:

$$ω = 2 π f \\ c = f λ , \\ ω = 2 π c / λ \\ ε = 2 √ ( {2}_{{ε}_{0}} ( 2 π c / λ ) ρ ) \\ ε = 2 √ ( 4 {πε}_{0} c ρ / λ ) \\ ε \approx √ ( ρ / λ )$$

### D. Results

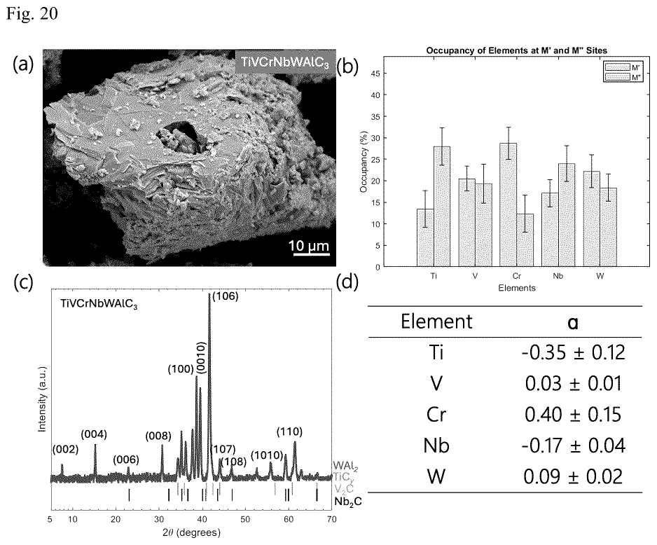

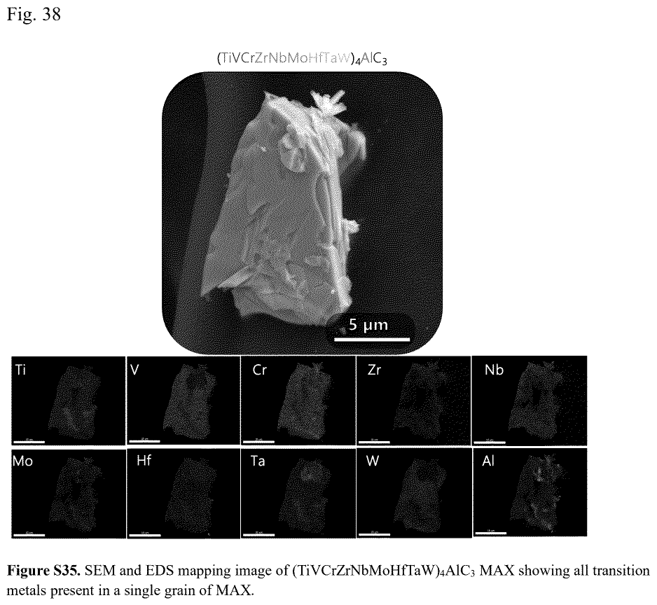

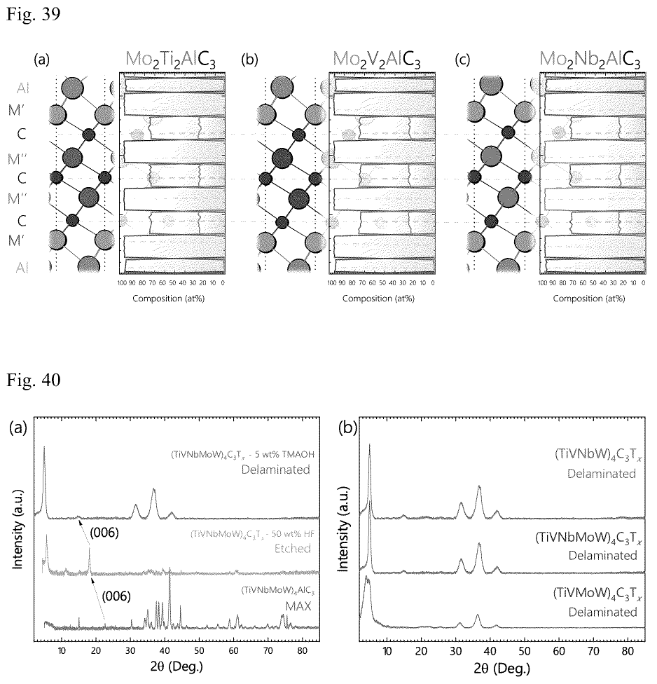

Our results show that SIMS indicates that Mo always occupies the M′ site and that Ti, V, and Nb always occupy the M″ site for equimolar M mixtures in the M₄AlC₃ MAX phases (FIG. 39; Figure S36). This agrees with FIG. 1c that Group 6 transition metals will primarily occupy M′ sites while Group 4 or 5 will occupy M″ sites. Further, to calculate this site preference for our M₄AlC₃ MAX phases with 4 or more transition metals, the difference in the atomic composition of each element in the M′ and M″ sites was divided by their sum to create an “α” parameter, where a positive α indicates a given M prefers the M′ site and a negative α indicates that a given M prefers the M″ site, respectively. Using this parameter, we noted that when 4 transition metals were placed into the M₄AlC₃ MAX phase, the trend in preference of a transition metal for an M′ or M″ site was the same as established for M₄AlC₃ MAX with two transition metals (Cr>Mo>W>V>Nb>Ta>Ti>Zr>Hf in M′ site) (FIG. 20). This agrees with FIG. 1c that an enthalpic preference for M′ or M″ site ordering of the transition metals is still present even for these entropy-stabilized M₄AlC₃ MAX phases.

Further, we observed increasing the number of transition metals to 5 and 6 results in a diminished |α| for each transition metal. In corroboration with FIG. 1c, this suggests that configurations with less preference for order are more likely to be stabilized by the increasing configurational entropy. For the SIMS data, this would result in a lower |α| for each transition metal, as ordered (following FIG. 1b) and disordered configurations of the transition metals would become observable in each transition metal layer. Probabilistically, however, we would not expect |α| to converge on zero yet in these low-to-medium entropy systems, as inverse-ordered configurations would not yet become stabilizable through entropy.

Conversely, beyond 7 transition metals, we observe that the |α| converges on 0 for all transition metals (FIG. 2e). The convergence of |α| to zero suggests that ordered, solid solution, and inverse ordered configurations are stabilized, which would likely result in equal probabilistic chances to observe any given configuration via SIMS measurements. We see further support for this hypothesis by plotting the standard deviation of |α| for all transition metals against the total number of transition metals (FIG. 2f), which further suggests that all configurations become entropy stabilizable at ≥7 transition metals. Overall, our computational and experimental results indicate that the loss of short-range ordering in high-entropy MAX phases is only achievable once configurational entropy can overcome the enthalpic barriers for all configurations. Broadly, this data demonstrates two key features: 1) entropy-stabilized systems can display a preference for short-range ordering, however, 2) systems only truly become “high-entropy” materials once entropy overcomes any remaining enthalpic preferences for short-range order.

Effect of Order Vs. Disorder on MXenes

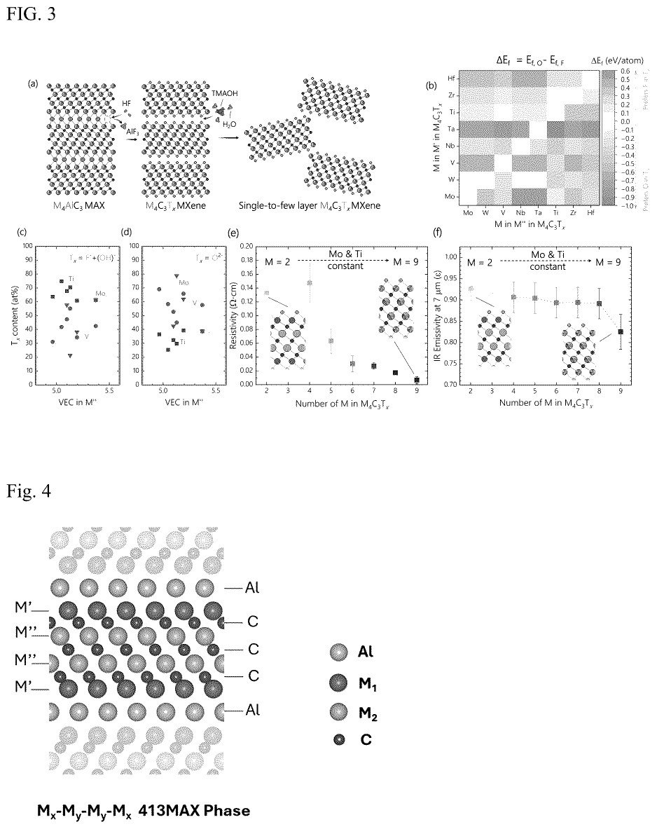

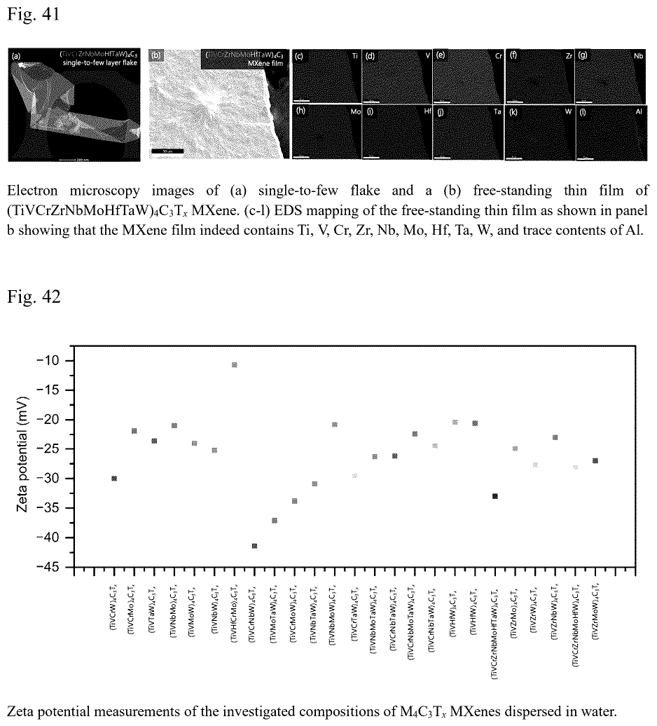

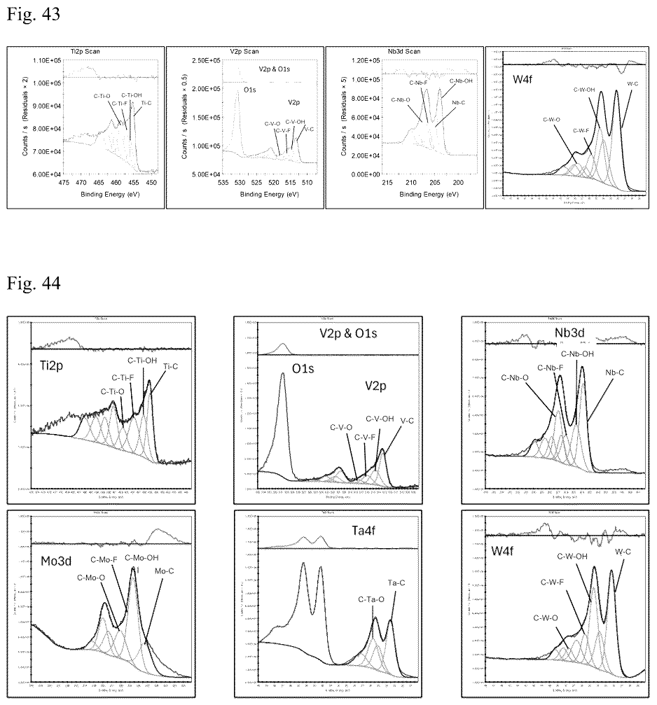

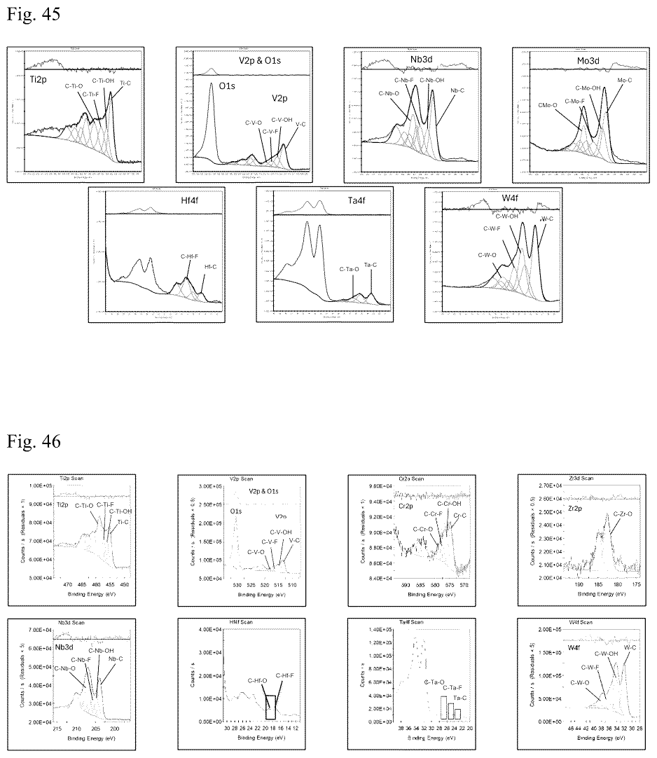

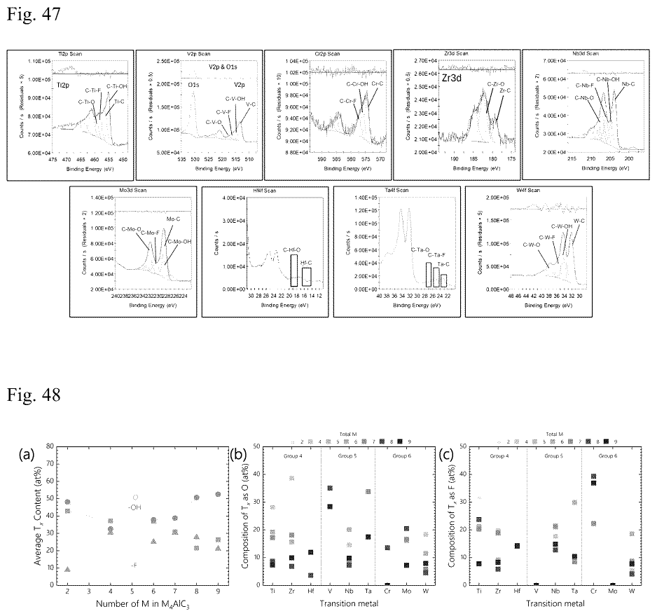

After confirming the synthesis and ordering behavior of the M₄C₃ structure in the M₄AlC₃ MAX phases, we evaluated the effect of order vs. disorder and composition on the individual M₄C₃ lamellas. To do so, we synthesized the M₄C₃Tₓ MXenes from their M₄AlC₃ MAX phases using wet chemical synthesis methods (FIG. 3a) (26, 29, 30, 32), which causes the MXene surface to be terminated with Tₓ groups, commonly —O, —(OH), and —F. After the synthesis, we confirmed that we were able to yield 2D flakes of MXenes (FIG. 40-41; FIGS. S37-38). Although all 2D MXenes produced in this study were stable in water (Figure S39), using x-ray photoelectron spectroscopy (XPS), we observed that the overall composition of Tₓ in the M₄C₃Tₓ MXenes containing 4 to 9 transition metals increased for —O (˜33 at % to ˜53 at %) and decreased for —OH (˜37 at % to ˜26 at %) and —F (˜30 at % to 21 at %) (FIG. 43-48; Figure S40-45 & Table 3; Table S1).

TABLE 3
(Table S1.) XPS peak convolution assignment
used in this work. [refs]

| Region | BE (eV) | | FWHM (eV) | Assigned to |
|---|---|---|---|---|
| Ti 2p | 455.2 | 460.5 | 1.34 | Ti—C |
| | 456.1 | 461.5 | 1.5 | C—Ti—OH |
| | 457.2 | 462.7 | 1.77 | C—Ti—F |
| | 458.9 | 464.7 | 1.87 | C—Ti—O |
| V2p | 513.4 | 520.8 | 1.56 | V—C |
| | 515 | 522.1 | 2.15 | C—V—OH |
| | 516.2 | 523.5 | 1.8 | C—V—F |
| | 517.7 | 525.7 | 2 | C—V—O |
| Nb3d | 202.4 | 205.1 | 0.9 | Nb—C |
| | 203.9 | 206.7 | 1.19 | C—Nb—OH |
| | 204.9 | 207.9 | 1.35 | C—Nb—F |
| | 206.1 | 208.8 | 1.46 | C—Nb—O |
| | 207.0 | 210.2 | 1.38 | Nb5 + (Nb2O5) |
| Mo3d | 228.6 | 231.6 | 1.19 | Mo—C |
| | 229.1 | 232.8 | 1.38 | C—Mo—OH |
| | 230.7 | 233.5 | 1.59 | C—Mo—F |
| | 232.1 | 234.8 | 1.06 | C—Mo—O |
| Cr2p | 574.7 | 583.9 | 1.99 | Cr—C |
| | 576.2 | 585.3 | 1.74 | C—Cr—OH |
| | 577.5 | 586.7 | 1.84 | C—Cr—F |
| | 578.9 | 588.1 | 2.34 | C—Cr—O |
| W4f | 32.4 | 34.0 | 1.4 | W—C |
| | 34.6 | 36.7 | 1.23 | C—W—OH |
| | 35.8 | 38.6 | 1.16 | C—W—F |
| | 37.8 | 39.7 | 1.65 | C—W—O |
| Zr3d | 179.4 | 181.4 | 1.64 | Zr—C |
| | 182.7 | 185.0 | 2.31 | C—Zr—O |
| Ta3d | 23.6 | 25.2 | 1.34 | Ta—C |
| | 25.8 | 27.3 | 1.58 | C—Ta —F |
| | 26.6 | 28.5 | 1.65 | C—Ta—O |
| Hf4f | 14.7 | 16.2 | 1.32 | Hf—C |
| | 17.3 | 19.0 | 1.55 | C—Hf—F |

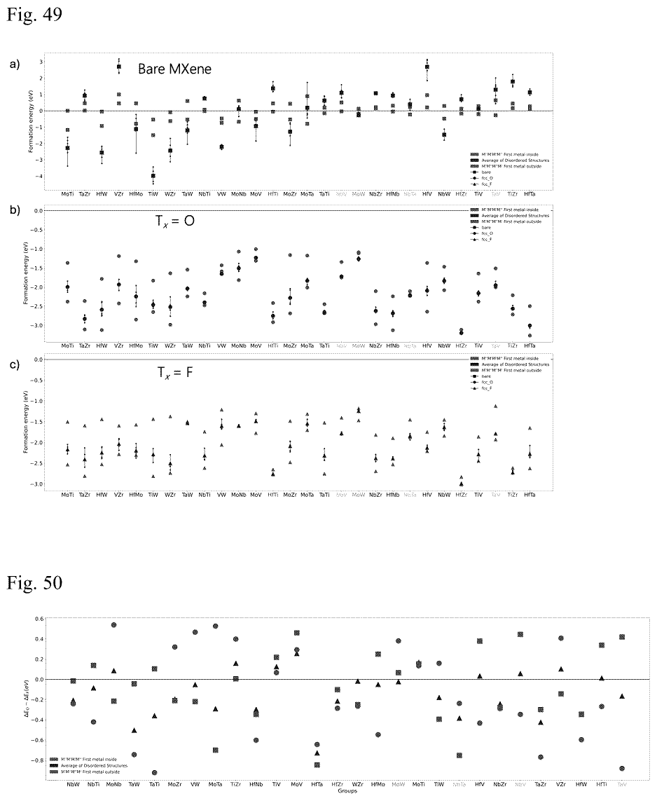

As a result, we believed that the ordering/disordering observed in the MAX phases would be present in the MXenes, and could be the source of the changes in the Tₓ group composition in their respective M₄C₃Tₓ MXenes. To gain insight into this trend, we used DFT to calculate the formation energy of —O and —F surface groups on MXenes with different pairs of transition metals in either M′ or M″ sites (FIG. 3b). We observed that pairs of Group 4 elements broadly prefer F terminations and pairs of Group 6 elements broadly prefer O terminations. We also observed that Group 6 in M″ causes an increased preference for Group 4 in M′ for O terminations and Group 4 in M″ causes an increased preference for Group 6 in M′ for F terminations. As shown in the supporting information (FIG. 49; Figure S46), we also observe that the solid solution combinations are, on average, between the two ordered configurations. The calculated values of O vs. F preference for both ordered and solid solution configurations of the paired transition metals are shown in Figure S47 (FIG. 50).

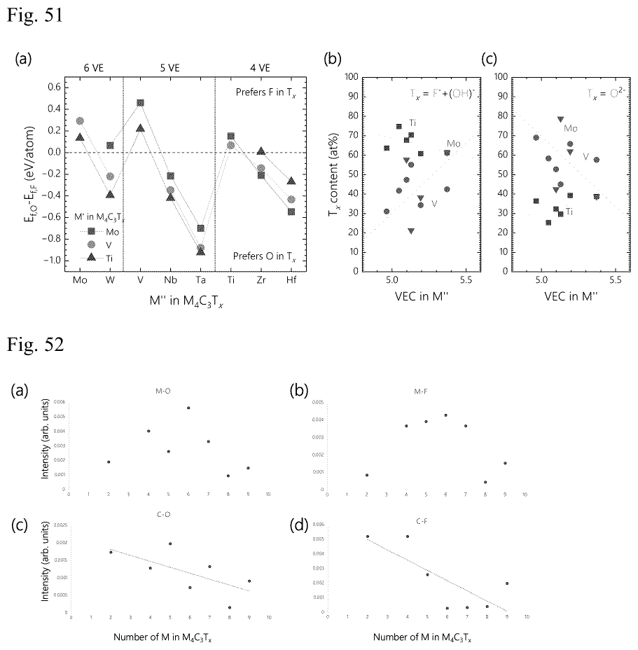

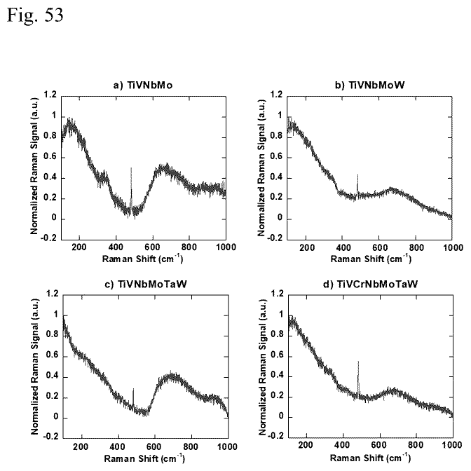

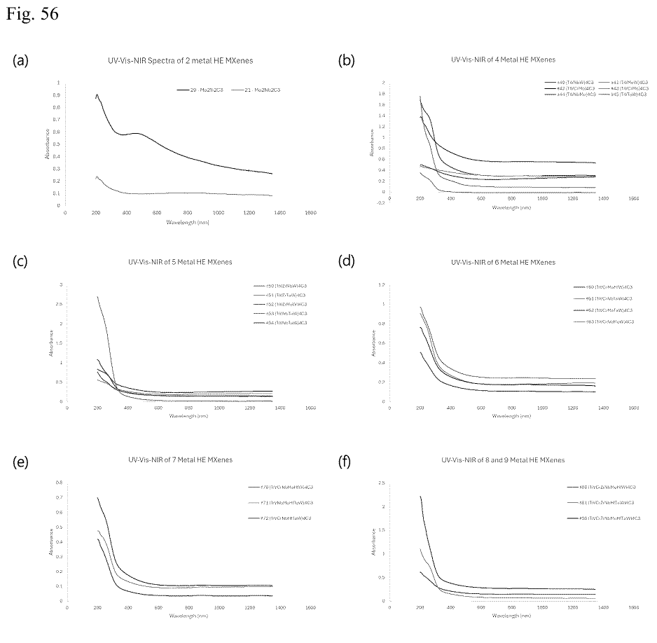

As we cannot know the subsurface M″ metal for any given M′ metal bound to Tₓ in our realized MXenes, we chose to plot the surface chemistry for Ti and W in M′ sites (bound to Tₓ) against the valence electron concentration (VEC) in the M″ sites, which was derived from SIMS. In addition, in this plot, we consider both —(OH) and —F terminations together and —O terminations separate, as —(OH) and —F would prefer a T⁻ oxidation state while O would prefer a T²⁻ oxidation state. Using this plot, we see that increasing the VEC in the M″ sites can increase the concentration of O terminations on Ti and —(OH)/F on V and Mo, which is broadly in agreement with the trends shown in FIG. 3b. A side-by-side comparison of the data in FIGS. 3b and 3c can be found in Figure S48 (FIG. 51). We see agreement with the general increase of O as a Tₓ group on M₄C₃Tₓ MXenes containing 4 to 9 transition metals (Fourier-transform infrared spectra in FIG. 52; Figure S49). In addition, using Raman and ultra-violet-visible-near infrared (UV-vis-NIR) spectroscopy, we gained some insight into the effect of disorder in our M₄C₃Tₓ MXenes by increasing the total number of transition metals (FIG. 53-56; Figures S50-53). Overall, this suggests surface vs. subsurface transition metals impact the chemical behavior of the MXenes. As previous works show the surface basal plane of MXenes is catalytically active, we believe that future studies could focus on the surface vs. subsurface interaction in these MXenes on the catalytic and sensing applications.

### Effects of Order-Disorder in MAX on the XRD Patterns

To begin to understand the potential effect of ordering in our M₄AlC₃ MAX phases, we further analyzed our XRD patterns. In previous literature, it has been shown that the intensity of the (002) and (004) peaks of MAX phases is significantly affected by the presence of elemental order. For example, Mo₂Ti₂AlC₃, with Mo in the M′ sites and Ti in the M″ sites (all calculated combinations shown in Figure S6; FIG. 9), has been shown to have a near non-present (002) peak compared to the (004) peak intensity (7). Broadly, when we calculated the (002)/(004) ratio for 33 synthesized M₄AlC₃ MAX phases containing transition metals from 2-9, we observed that the (002)/(004) peak intensity ratio trended from order to disorder when the total number of transition metals were increased (FIG. 10a-b; Figure S7a-b). In addition, to evaluate our lattice constants and the calculated strain in the structure due to multiple transition metal occupancies. As shown in Figure S7c in purple, we observed that our M₄AlC₃ MAX phases showed a measurable deviation (˜1.5% average for total M=4) from the expectations of a “perfect” solid solution occupancy, as calculable using Vegard's law. As shown in previous works on o-MAX phases, deviation from Vegard's law is expected in MAX phases when there is a preferential site occupancy for different metals. In addition, we note that this deviation decreases as the total number of M increases in the M₄AlC₃ MAX phases.

To further understand this behavior, we next calculated the lattice strain in the (106) peak reflection of MAX phases. In previous works, it is shown that having occupancies of multiple metals in the same atomic sites in the crystal lattices induces a measurable amount of microstrain on the lattice, which comes from mixtures of elements with different atomic sizes. If our structure was a full solid solution, we would expect the strain distortion to be maximized for mixtures of a few smallest transition metals (e.g., Cr or V) with the largest transition metals (e.g., Zr, Hf, Nb, Ta), which should maximize our strain for M₄AlC₃ MAX phases with 4 M rather than 6 or 7 M. However, we observed the inverse behavior in our M₄AlC₃ MAX phases with increasing M. For example, we calculated a lattice strain for (TiVTaW)₄AlC₃ of 0.21% while (TiVCrMoTaW)₄AlC₃ was 0.33%. As shown in Figure S4c in green, when we averaged these lattice strains, we saw the average lattice strain increase when we increased the total number of transition metals, which does not match expectations for solid solution occupation of the transition metal sites.

### Characterization of the Reported MAX Phases

FTIR Spectral Analysis presents the ATR-FTIR spectra of M-MXenes with varying compositions. The spectra exhibit characteristic peaks associated with the vibrational modes of M-O (550-650 cm-1), M-F (700-750 cm-1), C-F (1000-1200 cm-1), and C-O (1550-1700 cm-1). The peak positions and intensities provide valuable information about the types and relative abundance of surface terminations. The intensity of M-O vibrational peak is directly correlated with the concentration of oxygen terminations on the MXene surface. A higher intensity peak indicates a higher density of oxygen-terminated sites. The intensity of this M-F vibrational peak provides insights into the fluorine termination content. A more intense peak suggests a higher concentration of fluorine-terminated sites. The relative intensities of the M-O and M-F peaks were found to vary across different M-MXene compositions. This suggests that the metal composition can influence the preferred surface termination. While FTIR cannot specifically identify the metal involved in the M-O or M-F bonds due to the overlap of vibrational modes, it provides valuable information about the overall termination chemistry.

An interesting observation is the inverse relationship between the intensities of the M-O/F and C—O/F peaks. As the intensity of M-O/F peaks increases, the intensity of C—O/F peaks decreases. This suggests a competition between metal and carbon atoms for available termination sites. A possible explanation for this behavior is that as the number of metal atoms in the MXene increases, more metal-oxygen and metal-fluorine bonds are formed. This leaves fewer available sites for carbon atoms to bond with oxygen or fluorine, resulting in a decrease in the intensity of C—O/F peaks.

The surface termination chemistry of MXenes plays a crucial role in determining their physical and chemical properties, such as electronic conductivity, electrochemical performance, and catalytic activity. By understanding the factors that influence surface termination preferences, it is possible to tailor the properties of high entropy MXenes for specific applications. Introducing oxygen terminations to the surface of high entropy MXenes can significantly influence the electronic structure of carbon atoms within the MXene layers. This can be attributed to the electronegativity difference between carbon and oxygen atoms. Oxygen is more electronegative than carbon, meaning it attracts electrons more strongly. When oxygen atoms bond to carbon atoms at the MXene surface, they tend to withdraw electron density from the carbon atoms, resulting in a partial positive charge on the carbon atoms. This reduction in electron density around the carbon atoms can affect their electronic properties, such as their ability to donate or accept electrons.

The increased electron density on oxygen atoms may stabilize the M-O bonds, making the MXene surface more resistant to further oxidation. This can be particularly important for applications in harsh environments where oxidation is a major concern. The reduced electron density on carbon atoms can affect the overall electronic conductivity of the MXene. In some cases, oxygen termination may lead to a decrease in conductivity, while in others, it may create new electronic states that enhance conductivity. The change in electron density on carbon atoms can influence the adsorption and desorption of molecules on the MXene surface. This can have implications for catalytic applications, where the ability of the MXene to interact with reactant molecules is crucial.

The normalized Raman spectra using a 532 nm laser of MXene sheets with various compositions are presented in Figure S50 (FIG. 53). On observing the 100-300 cm⁻¹ region, where A_{1g} cross-plane vibrational modes between transition metals and carbon layers are prevalent, there is a distinct trend as the transition metal variety increases. Notably, (TiVNbMo)₄ C₃ shows identifiable peaks near 200 cm⁻¹ and 350 cm⁻¹, but these peaks shift to a downward-sloping baseline as the number of transition metals increases, indicating that a higher variety of metals influences scattering vibrational modes and leads to signal broadening, a phenomenon that has been previously noted in multicomponent MXene.

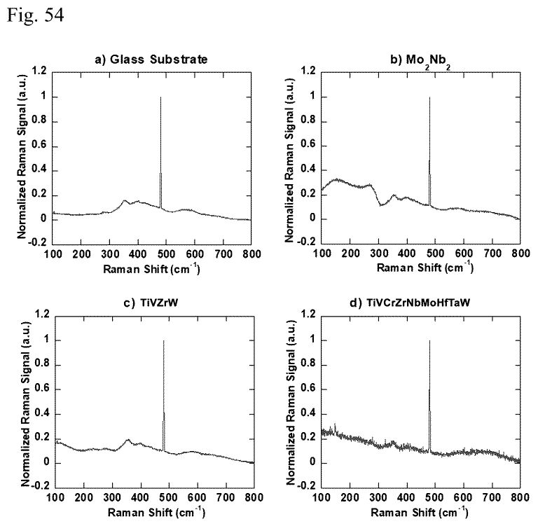

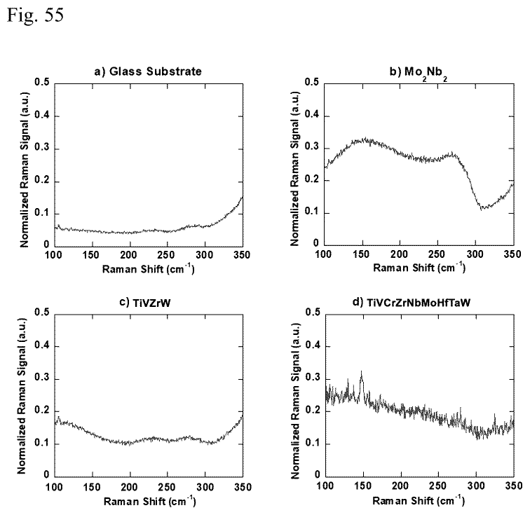

To obtain further insight into the composition influence on the Raman spectra, Raman measurements were performed on MXene flakes. These flakes were prepared by drop-casting diluted MXene solutions onto glass substrate. The normalized Raman spectra ranging from 100 to 800 cm⁻¹ of MXene flakes with various compositions are presented in FIG. 551. To focus on the MXene signal, the enlarged Raman signal for various MXene flakes within the 100 to 350 cm⁻¹ range, where the influence from glass substrate is minimal, has been presented in Figure S52 (FIG. 55). Figure S51 (FIG. 54) and Figure S52 (FIG. 55) were collected with the same experimental settings and conditions.

Further analysis reveals that highly ordered structures, such as the Mo₂Nb₂C₃ MXene, exhibit strong signals within this region, whereas the introduction of structural randomness by additional metals (e.g., Ti, V, Zr, W) decreases the signal strength, as seen in comparisons between Figures S52b and S52c (FIGS. 55b and 55c). Similarly, peak broadening is observed between MXene with four (TiVNbMo)₄C₃ and nine transition metals (TiVCrZrNbMoHfTaW)₄C₃, indicating that increased metal diversity correlates with broader, less distinct spectral features.

Similarly, peak broadening can also be observed from comparing (TiVNbMo)₄C₃ MXene to (TiVCrZrNbMbHfTaW)₄C₃ MXene, which are Figures S52c and S52d (FIGS. 55c and 55d), respectively. Having similar structures for MXene, the only difference is the amount of different transitional metal content. Interestingly, the MXene with nine different transitional metals exhibits a stronger overall signal; however, this signal is markedly broad, resembling a downward-sloping linear trend. This observation suggests that the increased transition metal variety contributes to extensive peak broadening, thus reducing the distinct spectral feature, like what was observed with MXene sheets.

Overall, it is observed that the transition metal composition in MXene structure impacts Raman spectral features. Increased metal variety results in broadened peaks signal profile, suggesting an influence on vibrational modes and scattering properties. This observation provides empirical evidence that the variety of transition metals in MXene compositions affects the Raman response, critical for understanding structural and vibrational dynamics in MXene materials. However, further analysis of the Raman spectra of these MXenes is necessary.

Properties of M₄C₃Tₓ MXenes Containing 2-9 Transition Metals

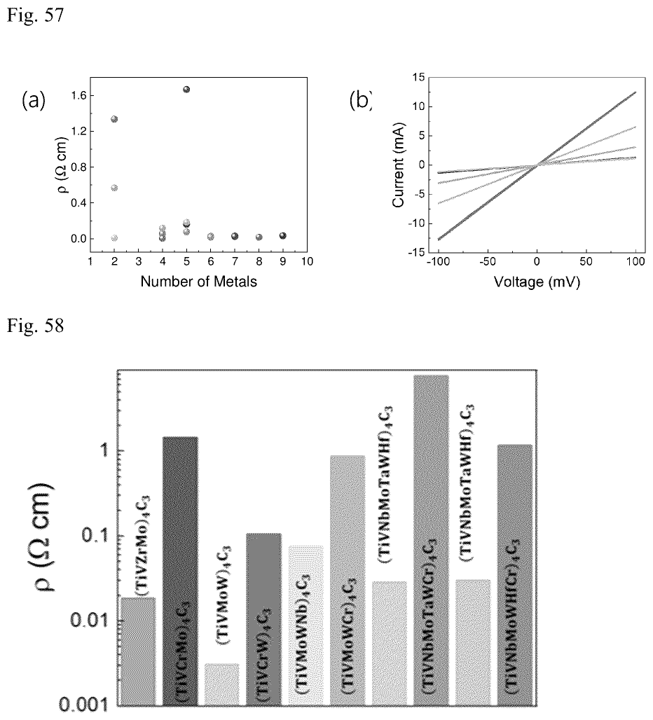

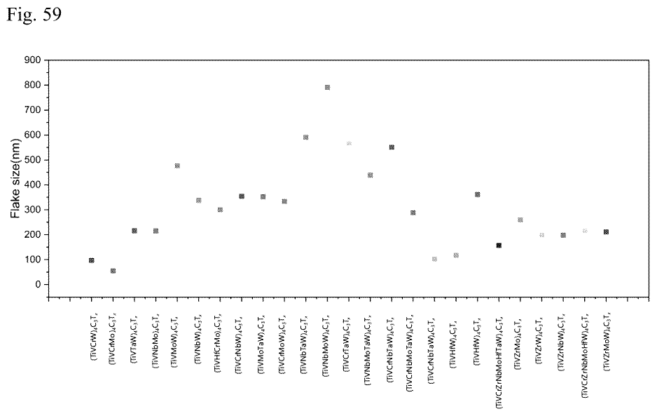

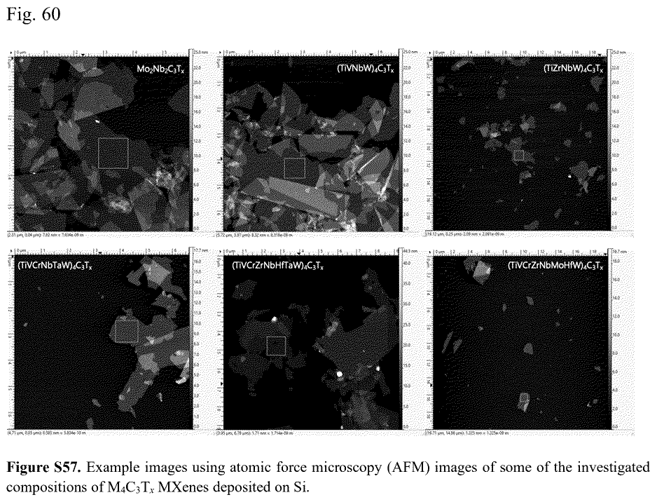

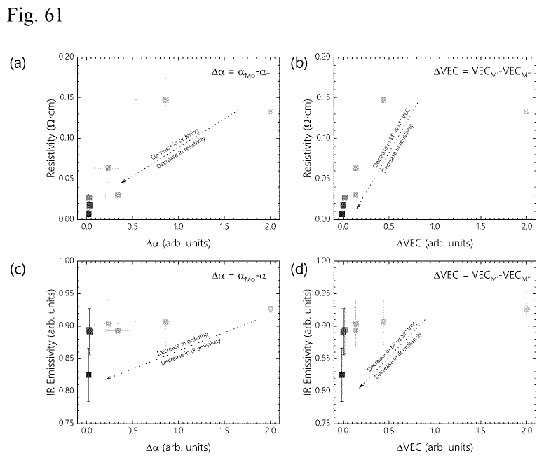

At this point, we evaluated the effect of multiple transition metals and order vs. disorder on the electrical properties of thin films of these M₄C₃Tₓ MXenes. When we investigated the M₄C₃Tₓ MXenes containing 2-9 transition metals, we found that the MXenes retain their metallic conducting behavior (FIG. 57; Figure S54). In addition, we noted that MXenes that contained Cr were up to an order of magnitude higher in electrical resistivity (FIG. 57; Figure S54), which is reported for high-entropy alloys. The flake sizes are shown using dynamic light scattering measurements in Figure S56 with atomic force microscopy images in Figure S57 (FIG. 60).

In previous literature, decreasing electrical resistivity has been reported for increasing numbers of transition metals in high-entropy alloys, however, the cause is not yet fully understood. In M₂C-type MXenes, computational work has shown Group 5 transition metals in MXenes should lower the electrical resistivity while Group 6 transition metals MXenes have a higher electrical resistivity. Overall, in our high-entropy M₄C₃Tₓ MXenes, we expect an increasing number of transition metals should cause disorder of Group 5 and 6 transition metals throughout the M₄C₃Tₓ structure. Therefore, we first plotted the electrical conductivity of our M₄C₃Tₓ MXenes against the total number of transition metals, as shown in FIG. 4d. In FIG. 4d, we chose to keep Ti and Mo as consistent transition metals, and systematically add one transition metal at a time to maintain comparability between samples. For example, at M=2, we show the fully ordered Mo₂Ti₂C₃Tₓ, at M=4 we show the low entropy (TiVNbMo)₄C₃Tₓ, and then add W, Ta, Cr, Zr, and Hf for M=5, 6, 7, 8, and 9, respectively.

In the data plot, we can see the original resistivity of Mo₂Ti₂C₃Tₓ at 0.13 Ω·cm, which initially increases for (TiVNbMo)₄C₃Tₓ to 0.15±0.03 Ω·cm, and then decreases to 0.01±0.01 Ω·cm (TiVCrZrNbMoHfTaW)₄C₃Tₓ. In addition, we see a similar behavior of the infrared (IR) emissivity behavior of these MXenes (FIG. 3f). This agrees with the trend in the changes in electrical resistivity shown in FIG. 3e, as decreasing electrical resistivity typically will result in a proportional decrease in IR emissivity. Broadly, we hypothesize that this decrease in resistivity could be attributed to two reasons (Figure S58): 1) the decrease in ordering results in fewer neighbors of Group 6 to Group 6 transition metals, or 2) the decrease in order creates structures with smaller differences in the total number of valence electrons (averaging to 5) between neighbors in both M′ and M″ layers, both of which could improve the electron mobility in the M′ and M″ layers. However, future studies are necessary to better understand the electron mobility and other properties in high-entropy MXenes and other high-entropy materials.

In summary, this work demonstrates a broad advancement in the understanding of the relation of enthalpy and entropy on short-range ordering in high-entropy materials. Specifically, by using M₄AlC₃ MAX phases with 2-9 transition metals and analyzing their structural ordering using SIMS, we were able to evaluate the trend in the short-range ordering of transition metals in either M′ or M″ sites against the total number of transition metals. Doing so, we have shown that 1) in low and medium entropy combinations (up to 6), the transition metals enthalpically prefer order in M′ or M″ sites, 2) at 7 M or above, the structures become fully disordered (no clear preference for M′ or M″), and that this order-disorder transition was 3) driven by an increasing contribution of configurational entropy. Lastly, we showed that these MAX phases can be used to synthesize their respective MXenes, which allowed us to observe some effects of entropic-driven disorder in the MAX on the electrical and IR emissivity properties of the derived MXenes. Within layered ceramics & 2D material research, this article represents an advancement in the synthesis of MAX and MXenes containing up to 9 transition metals. In the broad scientific community, this work represents major progress in understanding the role of enthalpy and entropy in the formation and order-disorder transitions in high-entropy materials.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A Composition of matter defined by the general formula M1M2M3M4M5M6M7M8M9X₃, wherein: X is Carbon; and M1, M2, M3, M4, M5, M6, M7, M8 and M9 each represent a different transition metal selected from the group consisting of Ti, V, Cr, Zr, Nb, Mo, Hf, Ta, and W.

2. The composition of claim 1, wherein M1, M2, M3, M4, M5, M6, M7, M8 and M9 each represent a different transition metal selected from the group consisting of consisting of Ti, V, Cr, Zr, Nb, Mo, Hf, Ta, and W.

3. The composition of claim 1, wherein the composition is (TiVCrZrNbMoHfTaW)₄C₃.

4. The composition of claim 1, wherein the composition is a MXene.

5. The composition of claim 1, wherein the composition is produced by at least:
preparing a precursor MAX phase powder;
etching the MAX phase powder to obtain multi-layered MXene powder; and
determining the multi-layered MXene powder to obtain single-to-few-layered MXene flakes.

6. The composition of claim 5, wherein preparing precursor MAX phase powder includes mixing and reactive sintering elemental powders of equimolar ratio of transition metals to obtain one or more sintered MAX phase blocks.

7. The composition of matter of claim 5 wherein the MAX phase structures having the formula M₄AlC₃ with 4 transition metals selected from the group consisting of: (TiVNbTa)₄AlC₃, (TiVNbW)₄AlC₃, and (TiCrMoW)₄AlC₃.

8. The composition of matter of claim 5 with different formation energy when V and W occupy only M′ sites and Ti and Nb occupy only M″ sites in (TiVNbW)₄AlC₃, and, if Ti and Nb occupy only M′ sites and V and W occupy only M″ sites (labeled “inverse ordered”), and when the solid solution occupancies of Ti and Nb in M′ and M″ sites have a higher formation energy for (TiVNbW)₄AlC₃.

9. A method of producing a composition of matter defined by the general formula of M1M2M3M4M5M6M7M8M9X₃, the method comprising:
preparing precursor MAX phase powder;
etching the MAX phase powder to obtain multi-layered MXene powder; and
delaminating the multi-layered MXene powder to obtain single-to-few-layered MXene flakes having the general formula of M1M2M3M4M5M6M7M8M9X₃;
wherein:
X is carbon; and
M1, M2, M3, M4, M5, M6, M7, M8 and M9 each represent a different transition metal selected from the group consisting of Ti, V, Cr, Zr, Nb, Mo, Hf, Ta, and W.

10. The composition of claim 9, wherein the composition is (TiVCrZrNbMoHfTaW)₄C₃.

11. A composition of matter that is a film comprising M₄C₃Tₓ MXenes containing 2 to 9 transition metals wherein;
X is carbon;
M is selected from the group consisting of M1, M2, M3, M4, M5, M6, M7, M8 and M9, each represent a different transition metal selected from the group consisting of Ti, V, Cr, Zr, Nb, Mo, Hf, Ta, and W;
and Tx groups, selected from —O, —(OH), and —F.

12. The composition of claim 11 having the general formula (TiVNbMo)₄C₃Tx.

13. The composition of claim 12 having the general formula (TiVCrZrNbMoHfTaW)₄C₃Tx.
